(19) United States
(12) Patent Application Publication
(10) Pub. No.: US 2013/0179172 A1
(43) Pub. Date: Jul. 11, 2013

(54) IMAGE REPRODUCING DEVICE, IMAGE REPRODUCING METHOD

(71) Applicant: FUJITSU LIMITED, KAWASAKI-SHI (JP)

(72) Inventors: Yasufumi NAKAMURA, Kawasaki (JP); Yuki WAKAYAMA, Kawasaki (JP); Takashi TERASAKI, Kawasaki (JP)

(73) Assignee: FUJITSU LIMITED, KAWASAKI-SHI (JP)

(21) Appl. No.: 13/670,618

(22) Filed: Nov. 7, 2012

(30) Foreign Application Priority Data
Jan. 5, 2012 (JP) 2012-000745

(51) Int. Cl. G10L 21/00

(52) U.S. Cl. CPC G10L 21/00
USPC 704/275

(57) ABSTRACT

An image reproducing device connected to a reproducing unit that reproduces image data includes an extraction unit configured to extract first-condition-satisfying-image data that satisfies a first extraction condition from image data stored in a storage unit; a voice keyword extraction unit configured to extract a keyword that matches a voice input to a voice input unit; and a presentation unit configured to determine, while the first-condition-satisfying-image data is being reproduced by the reproducing unit, a second extraction condition based on a relationship between the first extraction condition applied when extracting the first-condition-satisfying-image data being reproduced and the keyword that has been extracted, and present information pertinent to second-condition-satisfying-image data that satisfies the second extraction condition among the image data stored in the storage unit.

### CROSS-REFERENCE TO RELATED APPLICATION

This patent application is based upon and claims the benefit of priority of the prior Japanese Patent Application No. 2012-000745 filed on Jan. 5, 2012, the entire contents of which are incorporated herein by reference.

### FIELD

The embodiments discussed herein are related to an image reproducing device and an image reproducing method.

### BACKGROUND

Conventionally, as digital cameras, mobile phones, and video cameras have become widespread in households, there is an increased demand to manage photographs and videos taken with these devices. For example, there is known a method of storing photographs and videos taken with these devices in an information processing device such as a personal computer having a high capacity storage device, and managing the photographs and videos by the photographed date, photographed place, and photographed people.

There is a system for spontaneously proposing photographs and videos having relevant contents to a user viewing photographs and videos with a personal computer. For example, on a website for sharing videos such as YouTube (registered trademark), when the user finishes viewing a particular video, a screen for letting the user select a relevant video is displayed (see, for example, non-patent document 1). Accordingly, the user may continuously view another relevant video.

Furthermore, there is known an image display system in which voice recognition is performed when a user speaks while contents are being displayed, keywords are extracted from the spoken words, and tags of the contents are registered based on the extracted keywords (see, for example, patent document 1). This system has a function of holding a histogram of the number of times each keyword is spoken when keywords are applied from voice recognition, and when switching images, images having similar histograms are selected.

Patent Document 1: Japanese Laid-Open Patent Publication No. 2010-224715

Non-patent Document 1: YouTube <URL:www.youtube.com/>

However, on a website for sharing videos such as YouTube (registered trademark), the relativity of videos is determined based on the access status of multiple users. Therefore, it is not possible to apply the feelings and emotions of a particular user viewing the video.

Furthermore, with the system described in patent document 1, similar images are displayed with the use of a histogram created by performing statistical processing on keywords applied according to words spoken by the user. Therefore, it is not possible to select a similar image without a tag, which has never been viewed by the user.

Furthermore, the similar images are not selected by applying the features of the contents, and therefore an image that is determined as being similar by coincidence may be displayed. Accordingly, the precision in determining similarity is questioned.

Thus, with the above conventional technology, there may be cases where images suited to the intentions of the user are not provided.

### SUMMARY

According to an aspect of the embodiments, an image reproducing device connected to a reproducing unit that reproduces image data includes an extraction unit configured to extract first-condition-satisfying-image data that satisfies a first extraction condition from image data stored in a storage unit; a voice keyword extraction unit configured to extract a keyword that matches a voice input to a voice input unit; and a presentation unit configured to determine, while the first-condition-satisfying-image data is being reproduced by the reproducing unit, a second extraction condition based on a relationship between the first extraction condition applied when extracting the first-condition-satisfying-image data being reproduced and the keyword that has been extracted, and present information pertinent to second-condition-satisfying-image data that satisfies the second extraction condition among the image data stored in the storage unit.

The object and advantages of the invention will be realized and attained by means of the elements and combinations particularly pointed out in the appended claims. It is to be understood that both the foregoing general description and the following detailed description are exemplary and explanatory and are not restrictive of the invention as claimed.

### BRIEF DESCRIPTION OF THE DRAWINGS

FIG. 1 illustrates how an image reproducing device according to a first embodiment of the present invention is used;

FIG. 2 illustrates a hardware configuration of the image reproducing device according to the first embodiment of the present invention;

FIG. 3 illustrates a logical configuration of the image reproducing device according to the first embodiment;

FIG. 4 illustrates an example of data stored in an image database;

FIG. 5 illustrates an example of data stored in an album rule database;

FIG. 6 illustrates an example of an album information database created according to the album rule database;

FIG. 7 illustrates contents of an XML file specified by the album information database;

FIG. 8 illustrates an example of data stored in a voice keyword database;

FIG. 9 is a flowchart indicating a flow of a main process executed by the image reproducing device according to the first embodiment;

FIG. 10 is a flowchart indicating a flow of a regular album creating process;

FIG. 11 is a flowchart indicating a flow of an album data creating process;

FIG. 12 is a flowchart indicating a flow of a view process;

FIG. 13 is a flowchart indicating a flow of a process of a voice recognition module;

FIG. 14 is a flowchart indicating a flow of a relevant album creating process;

FIG. 15 is a flowchart indicating a flow of a relevant album data creating process;

FIG. 16 illustrates an example of a displayed screen of an image display unit when an album is being reproduced;

FIG. 17 is an example of a displayed screen of an image display unit when a relevant album is created;

FIG. 18 illustrates how a list of relevant albums is displayed by an image display unit;

FIG. 19 illustrates an example of data stored in an image database according to a second embodiment;

FIG. 20 is an example of an image subject association table stored as an attachment in the image database according to the second embodiment;

FIG. 21 illustrates an example of data stored in an album rule database according to the second embodiment;

FIG. 22 illustrates an example of data stored in a voice keyword database according to the second embodiment;

FIG. 23 is a flowchart indicating the flow of a main process executed by an image reproducing device according to the second embodiment;

FIG. 24 is a flowchart indicating the flow of a voice keyword registration process executed by the image reproducing device according to the second embodiment;

FIG. 25 illustrates a logical configuration of the image reproducing device according to a third embodiment;

FIG. 26 illustrates an example of data stored in an enthusiastic word database;

FIG. 27 is a flowchart indicating a flow of a process executed by the image reproducing device according to the third embodiment; and

FIG. 28 is a flowchart indicating a flow of a process of a voice recognition module.

### DESCRIPTION OF EMBODIMENTS

Preferred embodiments of the present invention will be explained with reference to accompanying drawings.

### Embodiments

First Embodiment

In the following, a description is given of an image reproducing device and an image reproducing method according to a first embodiment of the present invention, with reference to accompanying drawings.

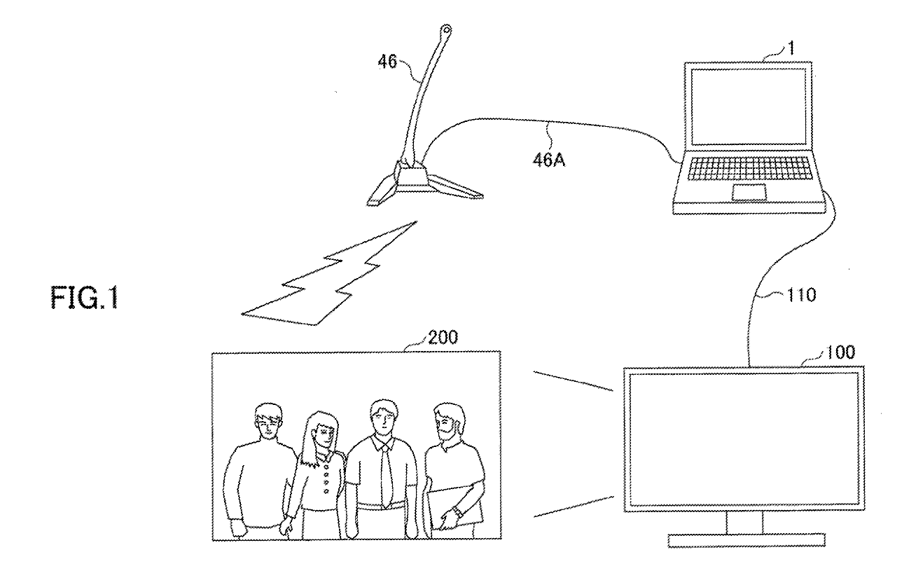

FIG. 1 illustrates how an image reproducing device 1 according to the first embodiment of the present invention is used. For example, the image reproducing device 1 is used by being connected to a microphone 46 and a television broadcasting device 100. The image reproducing device 1 and the microphone 46 are connected by, for example, a dedicated cable 46A, and the image reproducing device 1 and the television broadcasting device 100 are connected by, for example, a HDMI (High-Definition Multimedia Interface) cable 110. The images reproduced by the image reproducing device 1 are, for example, provided to users (viewers) 200 by the television broadcasting device 100. The television broadcasting device 100 is an example of a display unit. A dedicated monitor of the image reproducing device 1 which is an information processing device may be used as the display unit, and a projector may be used as the display unit. Furthermore, the microphone 46 may be built in the image reproducing device 1 which is an information processing device.
Hardware Configuration

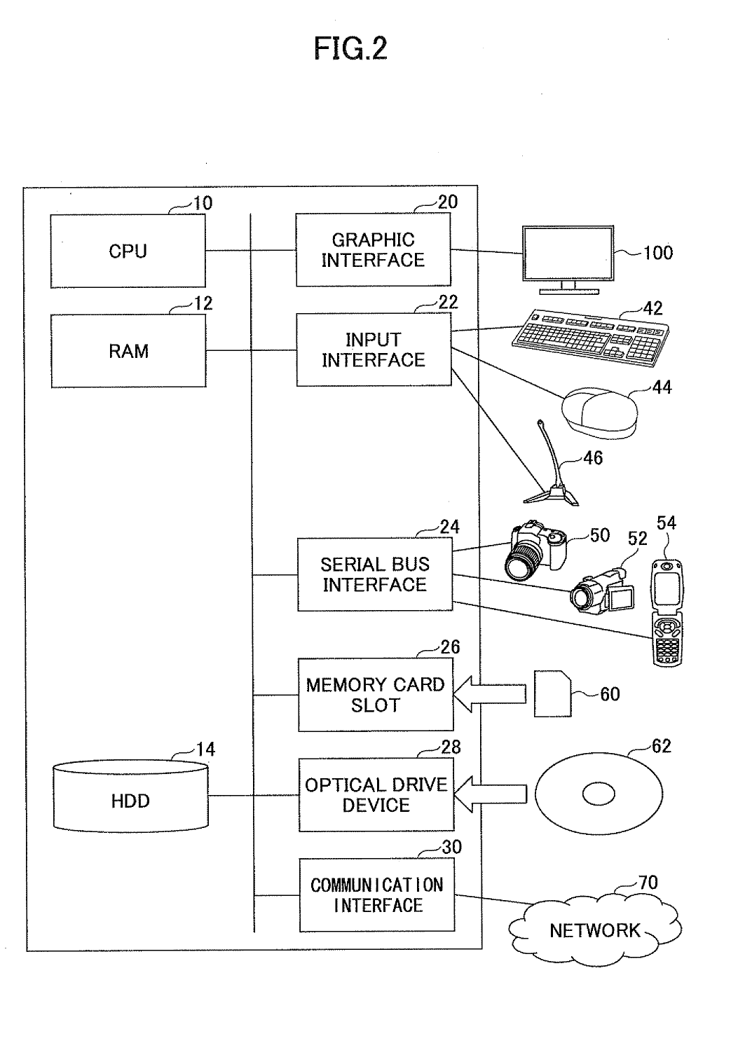

FIG. 2 illustrates a hardware configuration of the image reproducing device 1 according to the first embodiment of the present invention. The contents reproducing device 1 includes, for example, a CPU 10, a RAM 12, and a HDD (Hard Disk Drive) 14. Furthermore, the image reproducing device 1 includes a graphic interface 20, an input interface 22, a serial bus interface 24, a memory card slot 26, an optical drive device 28, and a communication interface 30.

This configuration is one example; the image reproducing device 1 may include a storage device such as a flash memory, an EEPROM (Electrically Erasable and Programmable Read-Only Memory), and a ROM (Read-Only Memory). Furthermore, the image reproducing device 1 may include a USB (Universal Serial Bus) connector for inserting a storage medium such as a USB memory.

The CPU 10 is a processor including a program counter, an instruction decoder, various computing units, a LSU (Load Store Unit), and a general-purpose register. The RAM 12 functions as a working memory, in which programs to be executed by the CPU 10 are loaded from the HDD 14, and execution results of programs are temporarily stored.

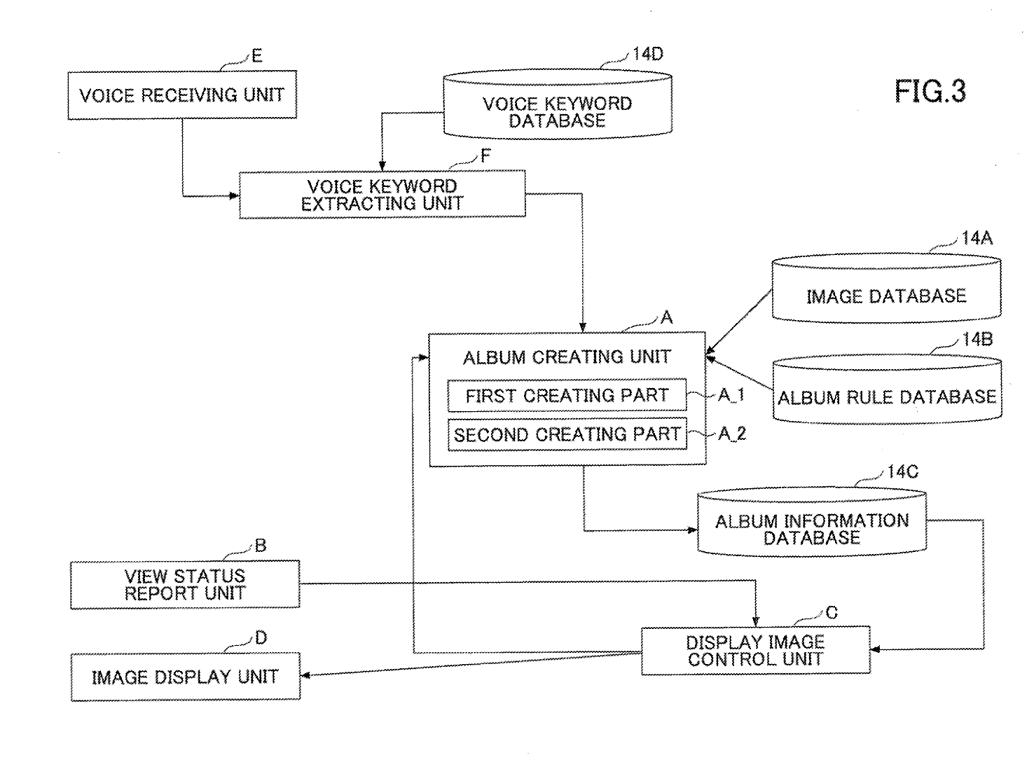

The HDD 14 stores various programs to be executed by the CPU 10, and data such as an image database 14A, an album rule database 14B, an album information database 14C, and a voice keyword database 14D (see FIG. 3). This data is stored in advance or created or updated according to a process by the image reproducing device 1.

Other than the above-described television broadcasting device 100, to the contents reproducing device 1, peripheral devices such as a keyboard 42, a mouse 44, and a microphone 46 are connected. The graphic interface 20 controls the display of the television broadcasting device 100, and the input interface 22 converts the operations input by the user to the keyboard 42 and the mouse 44 into signals, and outputs the signals to the main unit of the image reproducing device 1. Furthermore, the input interface 22 converts the speech input by the user to the microphone 46 into signals, and transmits the signals to the main unit of the image reproducing device 1.

To the contents reproducing device 1, devices such as a camera 50, a video camera 52, and a mobile phone 54 may be connected. The serial bus interface 24 holds contents data, and controls communications with these devices that are capable of transmitting contents data.

Furthermore, to the image reproducing device 1, a storage medium such as a memory card 60 and an optical disk 62 may be inserted. The memory card slot 26 reads contents data stored in the memory card 60 when the memory card 60 is inserted.

The optical drive device 28 reads the contents data stored in the optical disk 62 when the optical disk 62 is inserted.

The communication interface 30 controls communications with other computers via a network 70. The network 70 may be the Internet, a LAN (Local Area Network), and a wireless network.

Programs executed by the CPU 10 may be acquired from a storage medium such as the memory card 60 and the optical disk 62, and may be downloaded from another computer via the network 70 by the communication interface 30. Furthermore, programs executed by the CPU 10 may be stored in a secondary storage device or a ROM of the image reproducing device 1 in advance.

Image data acquired by the serial bus interface 24, the memory card slot 26, the optical drive device 28, and the communication interface 30 is, for example, image data of still images and video images.

The image data may be taken by devices such as the camera 50, the video camera 52, and the mobile phone 54, input to the contents reproducing device 1 via the serial bus interface 24, and stored in the HDD 14. The image data may be read from the memory card 60 by the memory card slot 26, and stored in the HDD 14. The image data may be read from the optical disk 62 by the optical drive device 28, and stored in the HDD 14. The image data may be acquired from another computer by the communication interface 30 via the network 70, and stored in the HDD 14. The image data group stored in the HDD 14 is handled as the image database 14A as described below.

In the following description, it is assumed that the image data has been taken by some device.
Logical Configuration

FIG. 3 illustrates a logical configuration of the image reproducing device 1 according to the first embodiment. The image reproducing device 1 includes an album creating unit A, a view status report unit B, a display image control unit C, an image display unit D, a voice receiving unit E, and a voice keyword extracting unit F.

Among these logical configurations, the album creating unit A, the view status report unit B, the display image control unit C, and the voice keyword extracting unit F are functional blocks that function as the CPU 10 executes programs stored in the HDD 14. The operations are not always implemented by programs clearly separated by these functional blocks. The operations may be called as subroutines and functions by other programs. Some of the functional blocks may be hardware units such as a LSI (Large Scale Integrated circuit), an IC (Integrated Circuit), and a FPGA (Field Programmable Gate Array).

The image display unit D corresponds to the graphic interface 20 and the television broadcasting device 100, and the voice receiving unit E is a function of the input interface 22.

The respective logical configurations in FIG. 3 perform processing with the use of the image database 14A, the album rule database 14B, the album information database 14C, and the voice keyword database 14D stored in the HDD 14.
Creating Albums

The album creating unit A includes a first creating part A_1 and a second creating part A_2. For example, the first creating part A_1 of the first or second embodiment corresponds to an “extracting unit”. For example, the second creating part A_2 of the first or second embodiment, the display image control unit C, and a voice receiving handler correspond to the “presenting unit”.

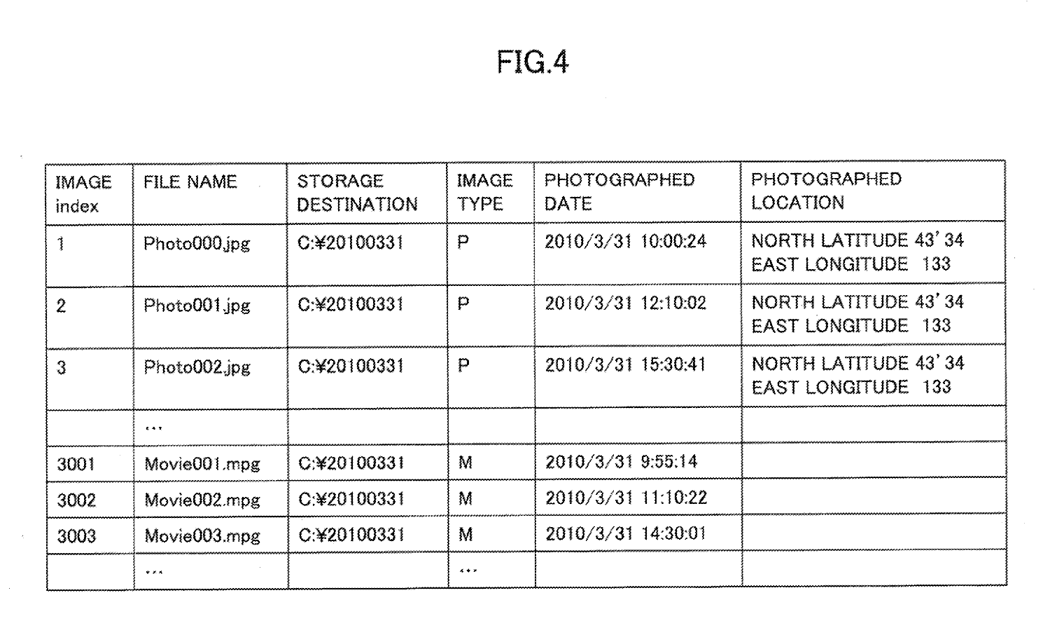

A description is given of a process of the first creating part A_1. FIG. 4 illustrates an example of data stored in the image database 14A. In FIG. 4, “image index” is a unique ID for uniquely identifying the image data. “File name” is the file name of the photograph/video in the image reproducing device 1. “Storage destination” is a path of a folder in which a file of the photograph/video is stored in the image reproducing device 1. “Image type” is specified as P when the image is a still image and M when the image is a video. “Photographed date” is the date when the image data is photographed when the image data is a photograph or a video. Usually, in a photograph taken with a commercially available digital camera, the photographed date is recorded in the Exif information of a photograph file, and therefore relevant information is transferred to the image database 14A. Furthermore, when the image data is video data, the photographed date may be determined by the time stamp of the file. “Photographed location” is information indicating the location where the photograph or video is photographed. There are commercially available digital cameras and video cameras that have a function of receiving information of GPS when taking the photograph or video and adding information to the photograph or video that has been taken. Furthermore, there is software for adding GPS information to photographs without location information by specifying a location on a map. Information added by using these means is described as “photographed location”.

The first creating part A_1 creates albums from the image database 14A at predetermined timings according to an extraction condition defined in the album rule database 14B. An “album” is an image data group including image data items collected according to a particular theme. For example, images are provided to the user in units of albums when presenting the images in the format of a slideshow. Albums created by the first creating part A_1 are stored in the album information database 14C. For example, an album according to the first or second embodiment corresponds to “first-condition-satisfying-image data”.

For example, the album creating condition (extraction conditions of image data) described in the album rule database 14B is a condition pertinent to the photographed date of the image. For example, the album creating condition is pertinent to the subject determined by a face recognition technology, or pertinent to information tagged to the photograph by another recognition technology. Furthermore, the album creating condition may be a combination of these conditions. Furthermore, the album creating condition is described by a combination of condition sentences for extracting a condition matching a particular condition.

The following are examples of album creating conditions. The following creating conditions include those used in the second and third embodiments described below.

Photographed within a particular period.
Example: “Album of 2007”

Album including a collection of images photographed in 2007

Photographed within a particular period every year.
Example: “Album of Golden Week”

Album including a collection of images photographed during April 29-May 5. Images are collected regardless of the photographed year as long as they are taken during this period.

Photographed within a particular time period.
Example: “Album of dusk”

Album including a collection of images photographed during a time period of 17:00-19:00, assuming that dusk is in this time period. Images are collected regardless of the photographed year/month/date.

A particular person is included in the image.
Example: “Album of Ms. A”

Album including a collection of images including a person named “Ms. A”, which is taken by recognizing this person by using the face recognition technology. The first creating part A_1 may use information that has been tagged beforehand to images including “Ms. A” by the user, instead of using the face recognition technology. Even when the face recognition technology is used, the user preferably associates beforehand a name with the face image used as a standard.

Photographed at a particular location.
Example: “Album of Hokkaido”

Album including a collection of images photographed at Hokkaido, by identifying the photographed location using GPS information attached to the images. The first creating part A_1 may use geographical information that has been tagged beforehand to the images by the user, when GPS information is not recorded in the images.

A particular subject is included in the image.
Example: “Album of trains”

Album including a collection of images tagged as “train” by using a technology of recognizing a train among the subjects included in an image. The first creating part A_1 may use information that has been manually tagged beforehand to the images including trains by the user, instead of using a technology of recognizing trains. Furthermore, the subject is not limited to trains. For example, the subject may be food such as “tuna at current price”, “foie gras”, and “Burgundy wine”, animals such as “cat” and “elephant”, plants such as “cactus”, and landmarks such as “Tokyo tower”. The first creating part A_1 may create albums using tag information attached to images of these subjects.

Combination of plural conditions described above.
Example: “Album of Ms. A at dusk in 2006”

Album including a collection of images photographed in 2006, at dusk, and including Ms. A as the subject.

Other than conditions for extracting images as described above, the album creating conditions include the maximum number of images to be included in each album. For example, when the number of images matching the condition exceeds this number, the first creating part A_1 randomly picks images to create an album.

The albums created by the first creating part A_1, including image data matching the extraction condition of the album rule database 14B, are stored in the album information database 14C.

The view status report unit B reports the status while a user is viewing images to other functional blocks. For example, the view status report unit B detects operations by the user via the input interface 22, and instructs the display image control unit C to start reproducing an album.

The display image control unit C selects an album from the album information database 14C according to an instruction from the view status report unit B, and causes the image display unit D to display the album. Furthermore, the display image control unit C performs a process on the information of the album presently being displayed to respond to a request from the album creating unit A.

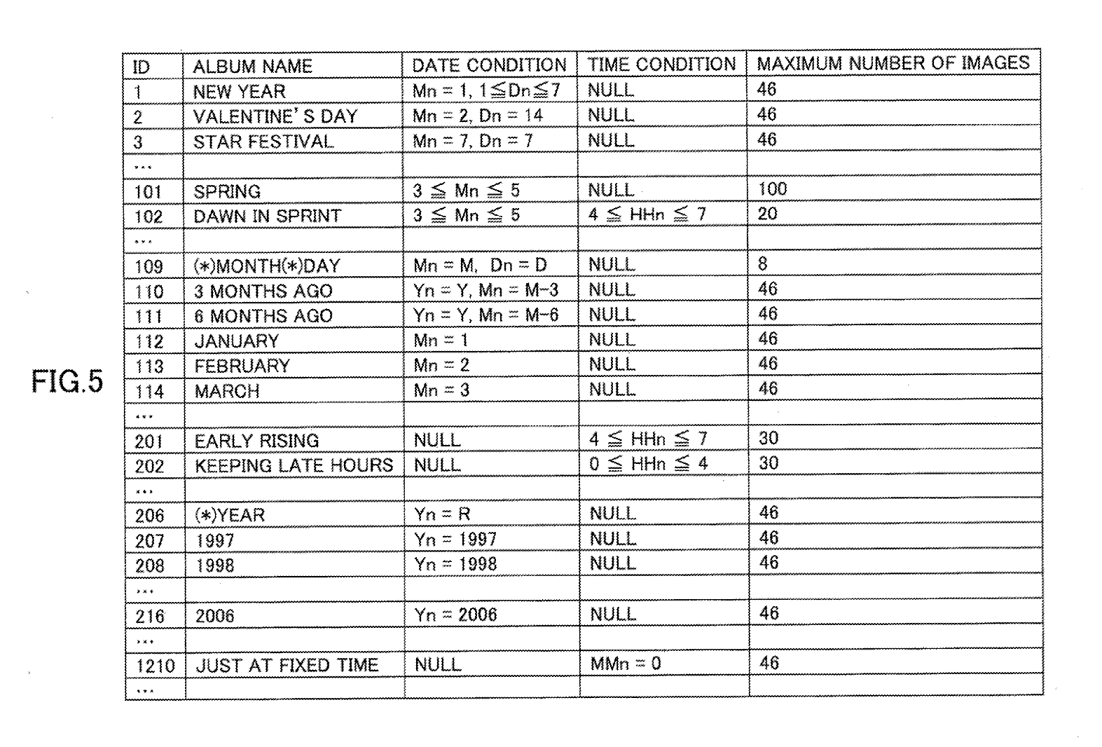

In the following, the album creating conditions are described in more detail. FIG. 5 illustrates an example of data stored in the album rule database 14B. In FIG. 5, “ID” is a unique value for uniquely identifying album rules. “Album name” is a name given to an album created according to an album rule. When there is a determined name preset in the system (for example, “New Year”), the determined name is described. When a name is determined at the time point when the system creates an album, a character (*) is described, and the name is determined at the time point when the album is created. For example, in the case of an album of ID=109, assuming that an album including a collection of images photographed on May 10 is created, values are filled into the parts of (*) so that the album name is “May 10”.

In “date condition” and “time condition”, conditions pertinent to a time period of the images collected when creating each album are described. The date condition is pertinent to the photographed date, and the time condition is pertinent to the photographed time. Depending on the type of album, the album may have only a date condition or only a time condition, or a combination of the date condition and a time condition. These conditions are indicated by values of the date condition and time condition in the record for each album. The rules for describing the date condition and the time condition are, for example, to describe the year of the date as Yn, the month of the date as Mn, the day of the date as Dn, the hour of the time as HHn, the minute of the time as MMn, and the second of the time as SSn, and to extract images that match these conditions. NULL means that there is no condition.

The rules for describing the date condition are defined as follows.

When there is a condition, the condition formula is described. When there is no condition, NULL is described.

As to values where no conditions are described, the values of the corresponding year, month, and date may be any possible value. For example, in the case of an album of “New Year” of ID=1, the date condition is “Mn=1, 1≦Dn≦7”, which indicates a condition that “among images of every year, collect images photographed during the period of January 1 to January 7”.

When Y is described as the value of the year, the year of the date of creating an album is assigned.

When M is described as the value of the month, the month of the date of creating an album is assigned. When D is described as the value of the date, the day of the date of creating an album is assigned. For example, when an album is created on May 10, 2011, the condition of the album of ID=109 is “Mn=M, Dn=D”. The values of M=5, D=10 are assigned, which indicates a condition that “among images of every year, collect images photographed on May 10”.

When values are subtracted from the values of Y, M, and D, the condition indicates to go back a number of days corresponding to the subtracted number. For example, when an album “three months ago” of ID=110 is created on May 10, 2011, the condition of the album is “Yn=Y, Mn=M-3”, and Y=2011, M=5 are assigned, which indicates a condition to “collect images photographed in February 2011”. When an album “six months ago” of ID=111 is created on May 10, 2011, and the condition of the album is “Yn=Y, Mn=M−6”, if Y=2011, M=5 are assigned, the value of the month becomes negative. In this case, +12 applied to the value of the month and −1 is applied to the value of the year. Consequently, the value of the month is 5-6+12=11, which indicates a condition to “collect images photographed in November 2010”.

A value R indicates that the value may be randomly selected. For example, in the case of the album of ID=206, the condition is “Yn=R”. When the value of R is randomly selected and R=2005 is obtained as a result, a condition to “collect images photographed in 2005” is indicated. Furthermore, (*) is included in the album name, so in this case, the album name becomes “2005”.

The rules for describing the time condition are defined as follows.

When there is a condition, the condition formula is described. When there is no condition, NULL is described.

As to values where no conditions are described, the values of the corresponding year, month, and date may be any possible value. For example, in the case of an album of “Just at fixed time” of ID=1210, the time condition is “MMn=0”, which indicates a condition that “among images of every hour, collect images photographed from 0 minute 0 second to 0 minute 59 seconds”.

For an album for which “date condition and time condition” are combined, for example, in the case of an album “Dawn in spring” of ID=102, the date condition is “3≦Mn≦5” and the time condition is “4≦HHn≦7”. This means “among images of every year, collect images photographed between 4 o'clock to 7 o'clock during the period of March to May”. Accordingly, an album including a collection of images photographed early in the morning in spring is created.

“Maximum number of images” indicates the maximum number of images used for each album. For example, in the case of the album “January” of ID=112, the maximum number is “46”. Even when there are more images that match the condition of the album than this maximum number, only the maximum number of images is actually used for the album. For example, assuming that there are 120 images photographed in January, only 46 images are selected and used for the album.

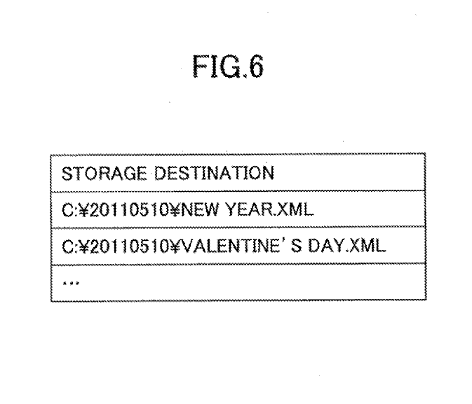

FIG. 6 illustrates an example of the album information database 14C created according to the album rule database 14B. For example, the album data is recorded in a single file according to a format of an XML file, and therefore the data illustrated in FIG. 6 describes the path of an XML file.

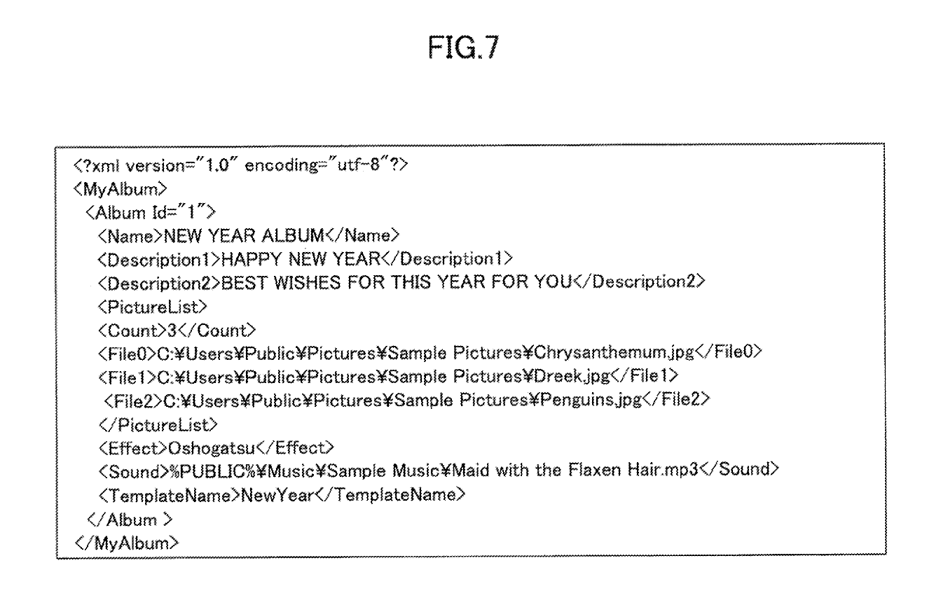

FIG. 7 illustrates contents of an XML file specified by the album information database 14C. In the following, a description is given of tags in the XML file. “MyAlbum” is a tag indicating that this is an album. “Album” is a tag indicating each album data. There may be plural sub-albums included in the album, and therefore “MyAlbum” may be divided by tags storing the respective album data items under “MyAlbum”. “Id” describes the ID of the album in the album rule database 14B. “Name” describes the name of the album. “Description1” and “Description2” are descriptions of the album displayed when the album is reproduced.

“PictureList” is a tag indicating a list of images included in the album, including the following tags. “Count” is the number of images. In the example of FIG. 7, the number is 3. In “File0”, “File1”, “File2”, the paths of the individual images are described. According to the number of images, the number accompanying “File” becomes larger.

“Effect” is a tag indicating the effects used when viewing an album. In the example of FIG. 7, the effect is “Oshogatsu”, meaning that the respective images are reproduced on a background image appropriate for New Year. “Sound” is a tag indicating the file name of BGM (Back Ground Music) used when reproducing an album. “TemplateName” is a tag indicating a template used when reproducing an album.
Creation of Relevant Albums Using Voice Information

Merely by reproducing an album created by the above-described method, there may be cases where the feelings and emotions of a user viewing the album are not applied.

The feelings and emotions of a user viewing the album are expressed by words unconsciously spoken by the user while viewing the album. The user may directly speak a word about an image that he wants to see now. For example, it is assumed that the user is viewing an “Album of 2008” with his family, including photographs and videos taken at events starting from the beginning of the year and on usual days. For example, when photographs taken during a trip to Paris in the beginning of August are displayed, conversations may take place looking back at scenes during the trip to Paris, such as “I enjoyed it”, “let's go again”, and “I remember seeing an aurora from the plane coming home”. Furthermore, conversations may take place that are relevant to actions to be taken after the trip to Paris, such as “remember we became enthusiastic about French food, and went to restaurants many times that year in autumn”, and “we went to Germany the next year”. In these conversations, it is considered that the feelings and emotions or intentions of the viewers are expressed.

In the image reproducing device 1 according to the present embodiment, the voice receiving unit E and the voice keyword extracting unit F extract particular keywords included in words spoken by the user, and creates a relevant album based on the extracted keywords.

The voice receiving unit E performs a digital signal process on a voice input to the microphone 46, and sends the signals to the voice keyword extracting unit F. The voice keyword extracting unit F determines whether a keyword stored in the voice keyword database 14D is included in the voices input as digital signals, and sends a keyword determined as being included to the album creating unit A (second creating part A_2). The voice keyword extracting unit F executes a process using a general voice recognition technology.

The voice keyword database 14D is a database storing keywords for setting, in advance, keywords for responding to received voices to perform voice recognition.

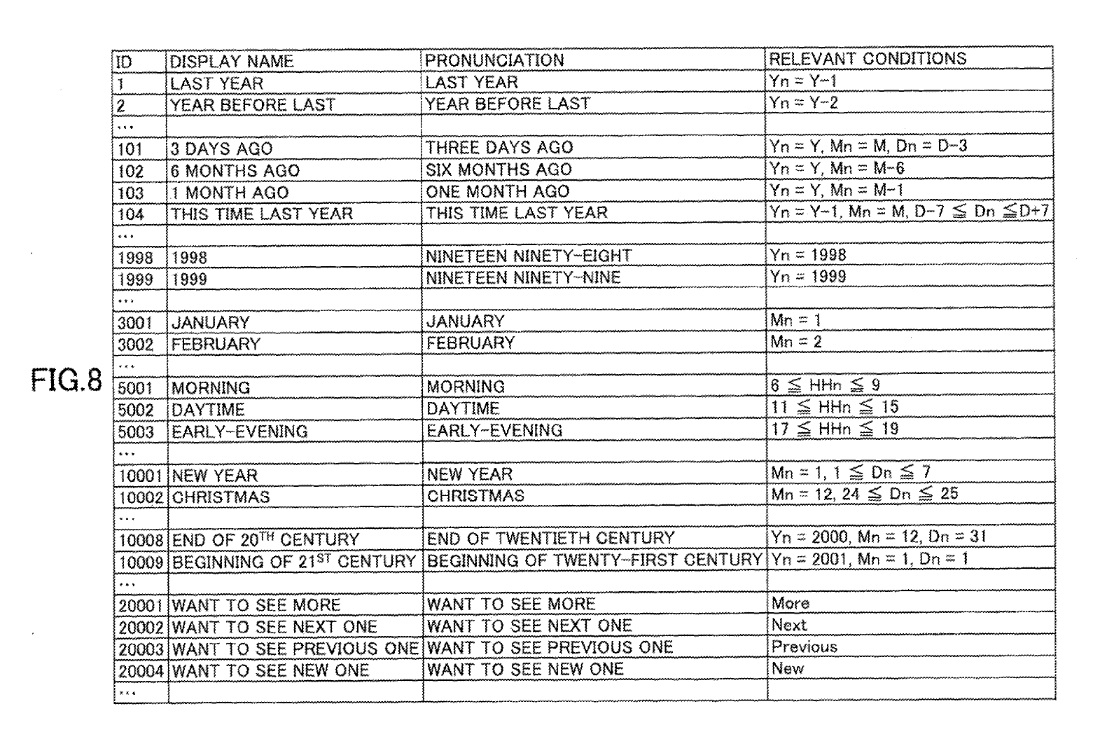

FIG. 8 illustrates an example of data stored in the voice keyword database 14D. “ID” is a unique ID for uniquely identifying a voice keyword. “Display name” is a character string used for displaying a voice keyword on a screen according to need. “Pronunciation” is a keyword for matching a voice input from the voice receiving unit E with a voice by a voice recognition technology. “Relevant conditions” describe conditions to be reported to the album creating unit A when a voice matches a keyword.

Similar to the rules for describing values of the date condition and the time condition described as described above, the relevant conditions describe the year of the date as Yn, the month of the date as Mn, the day of the date as Dn, the hour of the time as HHn, the minute of the time as MMn, and the second of the time as SSn, and conditions for these elements are described. For example, In the case of ID=1, “Yn=Y−1” is described in the field of relevant conditions, which indicates “a year obtained by subtracting one from this year, the month and day may be any value”. Supposing that today is May 10, 2011, the condition would mean “from the beginning to the end of 2010”.

In another example, in the case of ID=10008, “Yn=2000, Mn=12, Dn=31” is described in the field of relevant conditions, which indicates “Dec. 31, 2000”. In the case of ID=5001, “6≦HHn≦9” is described, which indicates “photographed date may be any date, photographed time is 6 o'clock to 9 o'clock, and minutes and seconds may be any value”. That is to say, the time period in the morning is expressed.

Furthermore, there may be conditions of different types from the date condition and the time condition. For example, in the case of “want to see more” of ID=20001, “More” is described in the conditions. This means a condition for narrowing down the time period. The contents to be narrowed down may vary according to the album being viewed. ID=20002 is “Next” and ID=20003 is “Previous”, which indicate a latter time (Next) and a former time (Previous), respectively. Specific conditions may vary according to the album. ID=20004 is “New”, which indicates that an album is to be created by new conditions.

The second creating part A_2 creates a relevant album based on the relationship between the received keywords and information of the album being reproduced acquired from the display image control unit C, at a timing when keywords are received from the voice keyword extracting unit F while the album is being reproduced. For example, a relevant album according to the first or second embodiment corresponds to “second-condition-satisfying-image data”.

According to a flow of the above process, it is possible to recognize a voice spoken by the user while viewing an album, and present an image that the user likely wants to see next. The image that the user likely wants to see next may include image data extracted by a condition obtained by narrowing down the original album rule, or image data extracted by a condition indicating a time period that comes before or after the time condition of the original album rule. Therefore, an image that suits the user's intensions is provided in a timely manner.
Process Flow

In the following, a detailed description is given of the album creating process, the album reproducing process, and the relevant album creating process described above.
Main Process

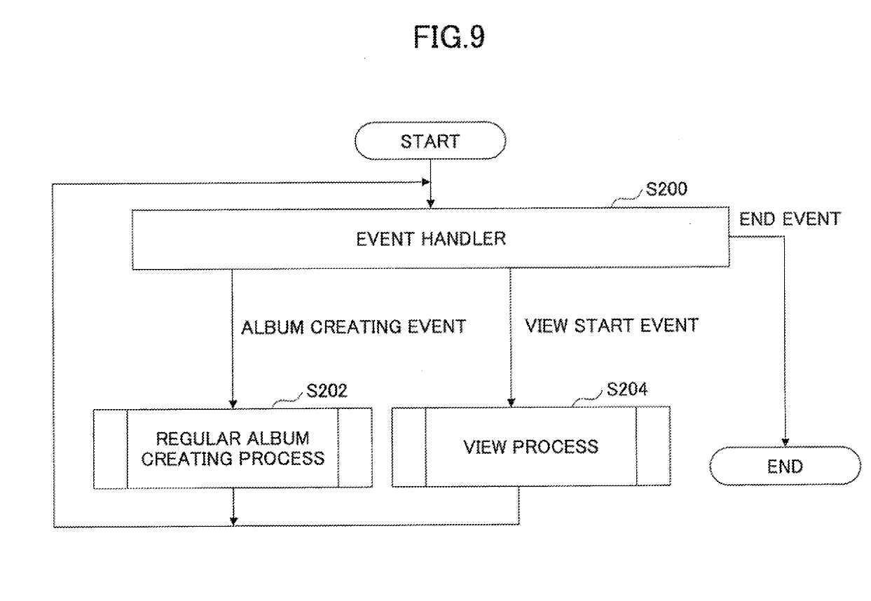

FIG. 9 is a flowchart indicating a flow of a main process executed by the image reproducing device 1 according to the present embodiment.

When the image reproducing device 1 is activated, an event handler becomes resident (step S200). The event handler is provided in various operating systems, and performs various processes in response to regular/irregular event reports.

When an “album creating event” is reported from the event handler, a “regular album creating process” starts (step S202). A regular album is an album created by the first creating part A_1 of the album creating unit A. For example, an album creating event is issued at the following timings.

Regularly issued with predetermined time intervals

Issued only once when system is activated

Issued only once when the date changes

Issued when image is taken into system

Furthermore, when a “view start event” is reported from the event handler, a “view process” is started (step S204). For example, a view start event is issued at a timing when the user activates an application for reproducing an album in order to view an album.

Furthermore, when an “end event” is reported from the event handler, the operating system itself is ended.
Regular Album Creating Process

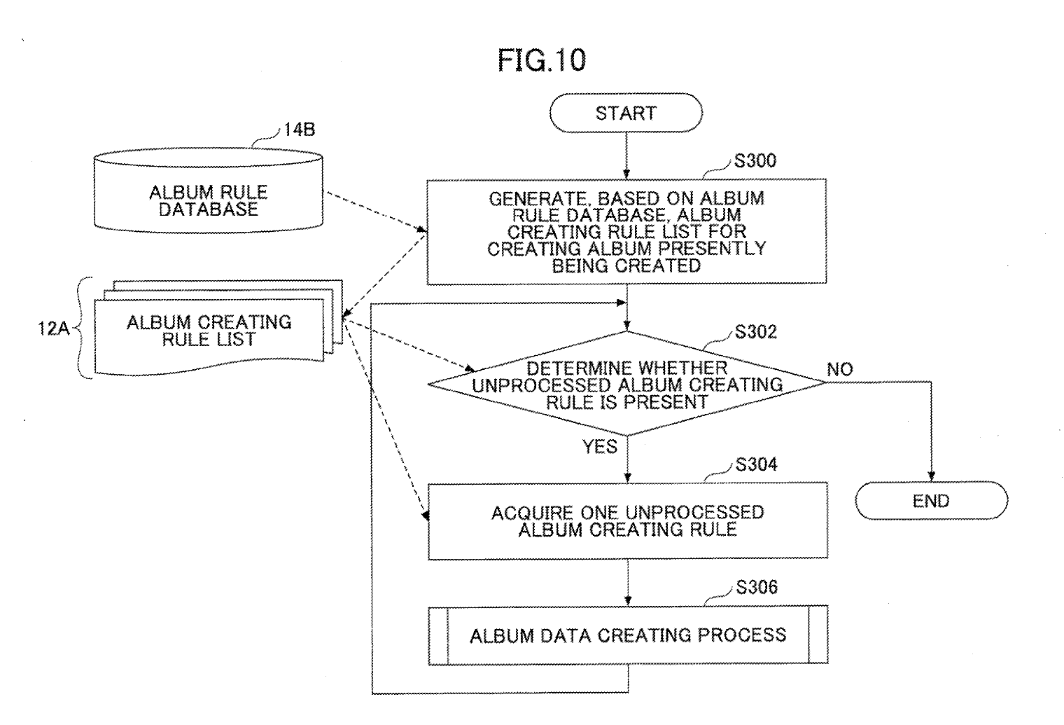

FIG. 10 is a flowchart indicating a flow of a regular album creating process.

When a regular album creating process is started, the first creating part A_1 generates, based on the album rule database 14B, an album creating rule list 12A that is an assembly of rules for creating the album presently being created, and stores the album creating rule list 12A in the RAM (step S300).

The album creating rule list 12A may include all of the rules described in the album rule database 14B, or may be an assembly of rules for selecting an album having appropriate contents in a case where the album is to be viewed on the date the album is created. For example, when the date the album is created is February 10, Valentine's Day (February 14) is close. Therefore, it is considered that the user wants to see images taken on previous Valentine's days, and creates an “album of Valentine's day” of ID=2. Furthermore, the type of album to be created may be narrowed down based on assumptions that the user is not willing to view images taken in mid-winter when it is mid-summer, and the user may want to look back at the whole year at the end of the year. The reason for narrowing down the type of album to be created is to report to the user in a timely manner when an album that is appropriate for viewing is created, or to aim for the effect of sustaining enjoyment by creating albums bit by bit.

Next, the first creating part A_1 determines whether an unprocessed album creating rule is present (step S302). When an unprocessed album creating rule is not present, the first creating part A_1 ends the process of the present flowchart.

When an unprocessed album creating rule is present, the first creating part A_1 acquires one unprocessed album creating rule from the album creating rule list 12A (step S304). The acquired unprocessed album creating rule is deleted from the album creating rule list 12A.

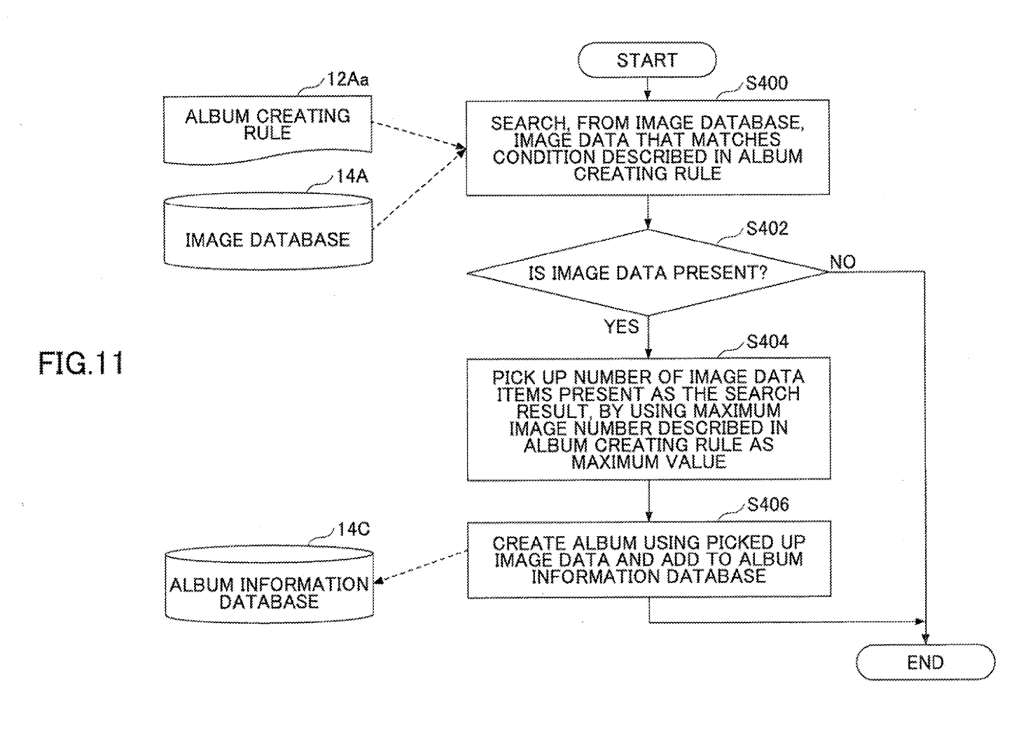

Next, the first creating part A_1 executes an album data creating process following the acquired album creating rule (step S306). The album data creating process is for creating an individual album following the album creating rule, which is described below with reference to FIG. 11.
Album Data Creating Process

FIG. 11 is a flowchart indicating a flow of an album data creating process.

First, the first creating part A_1 acquires the date condition and the time condition described in an album creating rule 12Aa that has been input, and searches, from the image database 14A, image data that matches the acquired date condition and time condition (step S400). The input album creating rule 12Aa is a rule acquired at step S304 of FIG. 10, from the album creating rule list 12A.

Next, the first creating part A_1 determines whether image data is present as a search result (step S402). When there is no image data present as a search result, the first creating part A_1 ends the process of the present flowchart.

When image data is present as a search result, the first creating part A_1 compares the number of image data items present as the search result and the maximum image number described in the album creating rule 12Aa. Then, when the number of image data items present as the search result is less than or equal to the maximum image number, the first creating part A_1 picks up the number of image data items present as the search result. When the number of image data items present as the search result is greater than the maximum image number, the first creating part A_1 picks up a number of image items corresponding to the maximum image number (step S404).

The method of picking up image data items corresponding to the maximum image number performed by the first creating part A_1 may be a method of randomly selecting images, or a method of picking up images after performing a process of excluding unsuccessful photographs such as blurred images or images that include subjects that are not supposed to be included.

Next, the first creating part A_1 creates an album using the picked up image data (step S406). The first creating part A_1 adds the created album to the album information database 14C, and ends the process of the present flowchart.

According to the above process, in the image reproducing device 1 according to the present embodiment, the created album is registered in the album information database 14C.
View Process

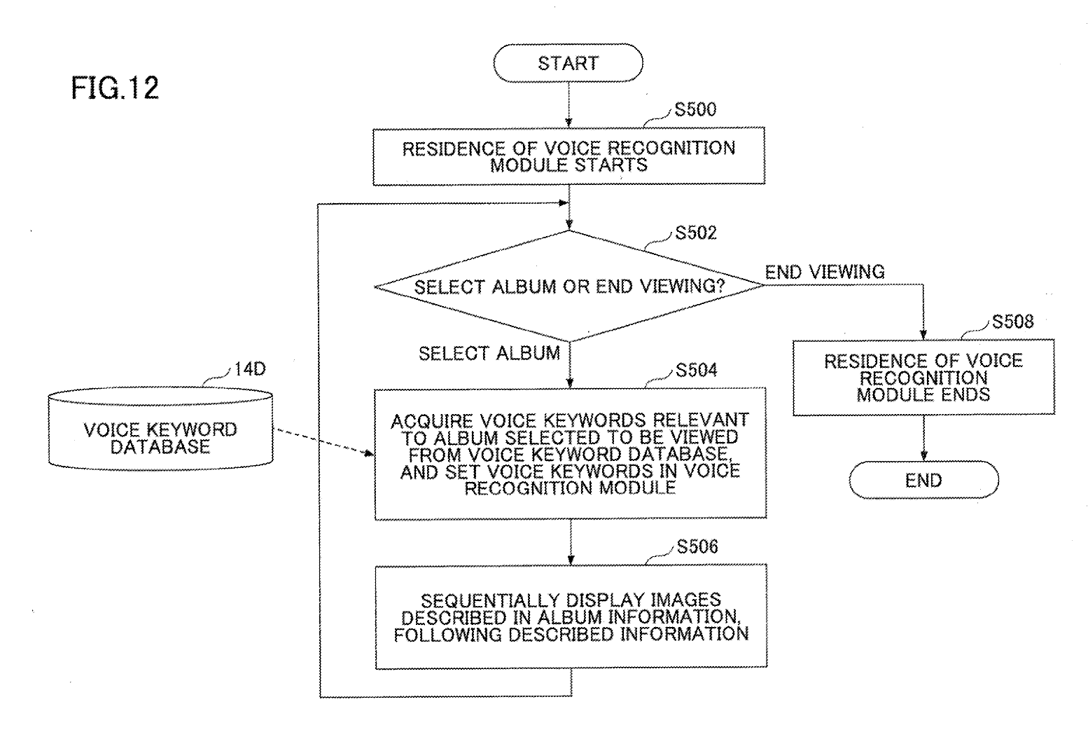

When a “view start event” is reported from the event handler, a “view process” starts. FIG. 12 is a flowchart indicating a flow of a view process. For example, a view process is executed by the display image control unit C.

First, the display image control unit C makes the voice recognition module become resident (step S500). The voice recognition module sets the voice receiving unit E so that voices from the microphone 46 are received, and the voice keyword extracting unit F makes preparations for consecutively analyzing the voices received from the voice receiving unit E.

Next, the display image control unit C waits until a user selects an album or selects to end viewing (step S502).

When the user selects an album, the display image control unit C acquires voice keywords relevant to the album to be viewed from the voice keyword database 14D, and sets the voice keywords in the voice recognition module (step S504).

Here, for acquiring the list of relevant keywords, for example, the display image control unit C uses a list in which the rules described in the album rule database 14B are associated with corresponding keywords. Then, the display image control unit C reads, from the list, a keyword corresponding to the rule ID described in the album that the user is going to view.

Next, the display image control unit C causes the image display unit D to display images identified by the album information, following the information described in the album information (step S506). Accordingly, the user starts to view an album. When a user speaks a voice during this time, the resident voice recognition module reacts, and performs the process of the voice recognition module described below. When the user finishes viewing an album or when the user performs an operation to view another album, the display image control unit C returns to step S502 and executes the process.

When the user selects view end, the display image control unit C ends the residence of the voice recognition module (step S508).
Process of Voice Recognition Module

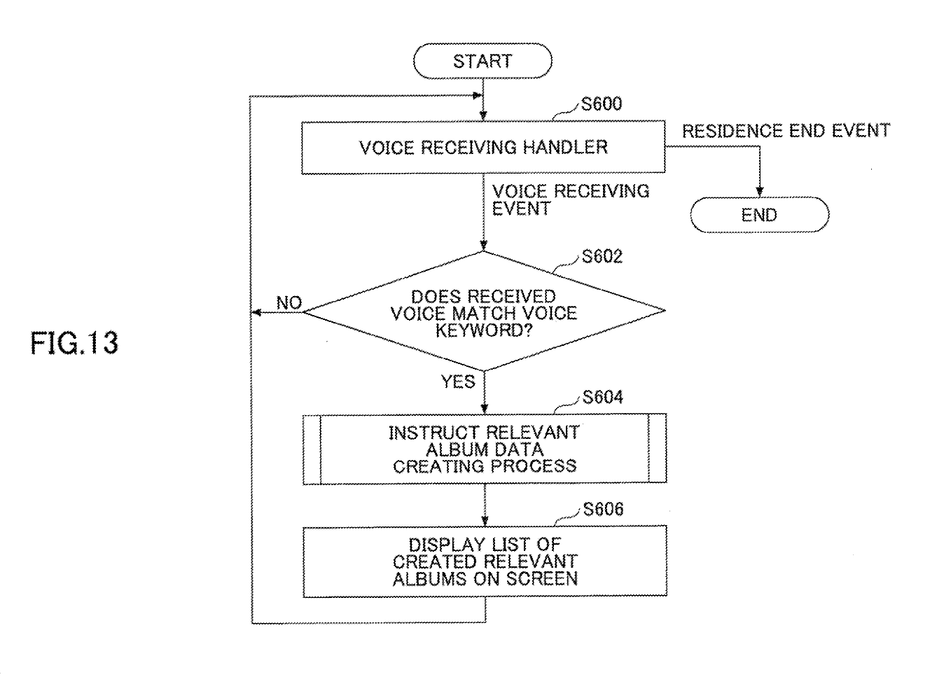

FIG. 13 is a flowchart indicating a flow of a process of a voice recognition module.

When the voice recognition module starts to become resident, the voice receiving handler is activated (step S600). The voice receiving handler waits to receive a message according to the event that has occurred.

When a voice receiving event is received, the voice receiving handler causes the voice keyword extracting unit F to determine whether the received voice matches a set voice keyword (step S602). When the received voice does not match the set voice keyword, the voice receiving handler returns to step

S600 and waits to receive a message.

Meanwhile, when the received voice matches the set voice keyword, the voice receiving handler instructs the second creating part A_2 to create a relevant album relevant to the album presently viewed by the user and the received keyword (step S604).

When the creation of the relevant album is completed, the voice receiving handler instructs the display image control unit C to display a list of created relevant albums 12C (described below) on a screen (step S606).

When a new voice receiving event is received while the second creating part A_2 is creating a relevant album, the voice receiving handler may perform a thread process, where a process of step S604 is performed in parallel with the present process. Furthermore, the voice receiving handler may ignore the reception of the next voice receiving event until the relevant album creating process is completed.

When the voice receiving handler receives a residence end event, the voice recognition module ends residence.
Relevant Album Creating Process

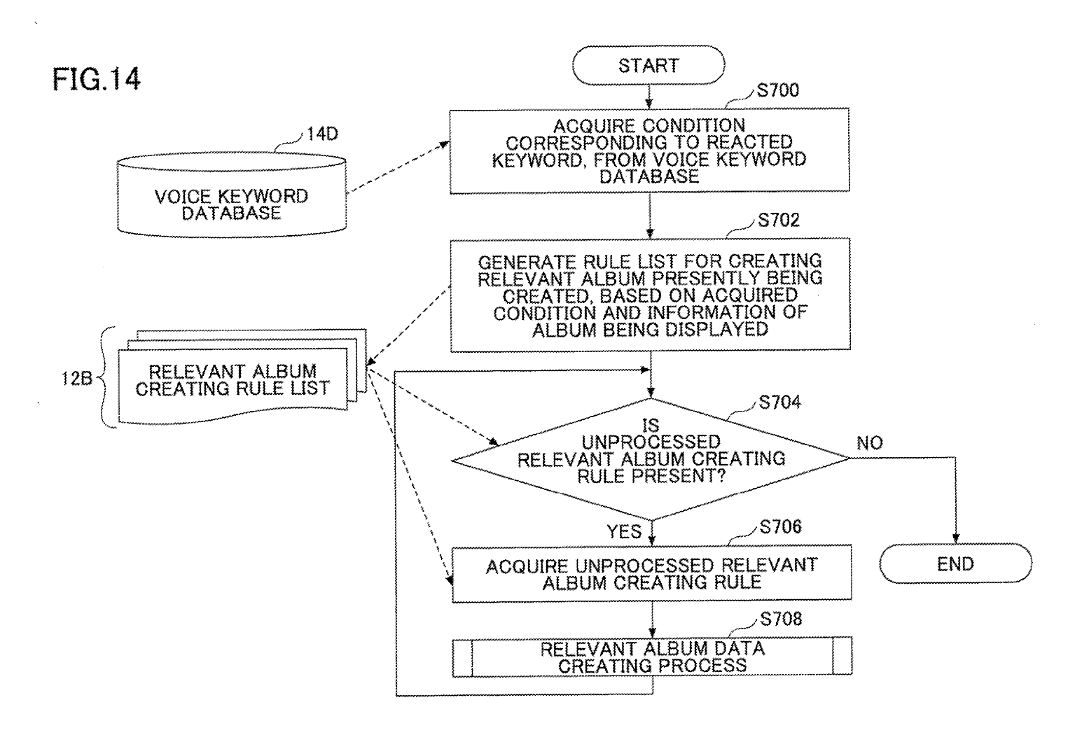

FIG. 14 is a flowchart indicating a flow of a relevant album creating process. The present flowchart starts when the voice receiving handler gives an instruction at step S604 in the flowchart of FIG. 13, and is executed by the second creating part A_2.

First, the second creating part A_2 acquires a condition corresponding to the voice keyword matching the voice, from the voice keyword database 14D (step S700).

A description is given of a process of acquiring a condition from the voice keyword. As illustrated in FIG. 8, when the voice keyword matching the voice is “last year”, “Yn=Y−1” is obtained as a relevant condition. Therefore, assuming that the present date is May 10, 2011, the condition corresponding to the voice keyword is “image photographed in 2010”,

Next, the second creating part A_2 generates a relevant album creating rule list 12B that is an assembly of rules for creating the relevant album presently being created, based on the condition acquired above and the information of the album presently being displayed (step S702).

In the process of step S702, the second creating part A_2 first acquires a corresponding album rule ID from the album information of the album presently being reproduced. Specifically, the second creating part A_2 is to read the value of “Album Id” described in the album information indicated illustrated in FIG. 7. When the album presently being displayed is “Album of new year”, the album rule ID is ID=1.

Next, the second creating part A_2 acquires the date condition and time condition of the album that matches the ID from the album rule database 14B. In the case of ID=1, the date condition is “Mn=1 , 1≦Dn≦7”, and the time condition is “none”.

Then, the second creating part A_2 determines the condition of the relevant album to be created presently. The second creating part A_2 determines whether the condition of a relevant album may be determined based on whether it is possible to take the logical product (AND) of the relevant condition acquired from the voice keyword database 14D, and the date condition and the time condition acquired from the album rule database 14B. For example, the second creating part A_2 makes the above determination based on the following rules. (A) When the relevant condition is pertinent to the date

(i) When it is possible to take the logical product (AND): A result obtained by taking the logical product (AND) is set as the condition.

(ii) When it is not possible to take the logical product (AND): The relevant condition is set as a new condition.

(B) When the relevant condition is not pertinent to the date

(i) In the case of More: A condition obtained by narrowing down the period of the album being viewed is set as the relevant condition.

(ii) In the case of Next: A period that comes next to the period of the album being viewed is set as the relevant condition.

(iii) In the case of Previous: A period that comes before the period of the album being viewed is set as the relevant condition.

(iv) In the case of New: Regardless of the album being viewed, a new relevant condition is set.

In the above example, the relevant condition is “Yn=Y−1”, the date/time condition is “Mn=1, 1≦Dn≦7”, and therefore when the logical product (AND) is taken among the conditions, “Yn=Y−1, Mn=1, 1≦Dn≦7” is obtained. The second creating part A_2 sets the obtained conditions as the condition for generating the relevant album.

When it is not possible to take the logical product (AND), for example, in a case where the voice keyword is “last year”, the album being viewed is “2006” of ID=216, and the date of viewing the album is May 10, 2011, the relevant condition is “Yn=2010” and the date/time condition is “Yn=2006”. In this case, when the logical product (AND) is taken, Yn=φ is obtained, and an AND condition is not generated. In this case, the second creating part A_2 sets “Yn=2010” as a new condition, and creates an album for 2010. The second creating part A_2 may set the condition for an album of the year 2010 as “Yn=2010”, or may create plural albums by dividing the year into periods. If the year is to be divided into two, the second creating part A_2 sets “Yn=2010, Mn≦6” and “Yn=2010, 7≦Mn” as the conditions, so that two conditions are generated for an album for the first half of 2010 and an album for the second half of 2010. In this case, in the relevant album creating rule list, two conditions are registered.

Furthermore, when the relevant condition is not pertinent to the date/time, the conditions are set as follows. In a case where the album presently being viewed is “February” of ID=113, the date condition is “Mn=2”. In this case, when the relevant information is as follows, the following conditions are registered in the relevant album creating rules.

In the case of More: the album is divided as “Early February”→date condition is “Mn=2, Dn≦10”, “Mid February”→date condition is “Mn=2, 11≦Dn≦20”, and “Late February”→date condition is “Mn=2, 21≦Mn”, and the respective conditions are registered.

In the case of Next: “March”→date condition is “Mn=3”.

In the case of Previous: “January”→date condition is “Mn=1”.

In the case of New: a condition randomly selected from the album rule list is registered.

When the second creating part A_2 generates the relevant album creating rule list 12B as described above, the second creating part A_2 determines whether an unprocessed relevant album creating rule is present in the relevant album creating rule list 12B (step S704).

When an unprocessed relevant album creating rule is present, the second creating part A_2 acquires the unprocessed relevant album creating rule from the relevant album creating rule list 12B (step S706), and performs a relevant album data creating process (step S708). When the relevant album data creating process is performed, the second creating part A_2 returns to step S704 and makes the determination.

When an unprocessed relevant album creating rule is not present, the second creating part A_2 ends the process of the present flowchart.

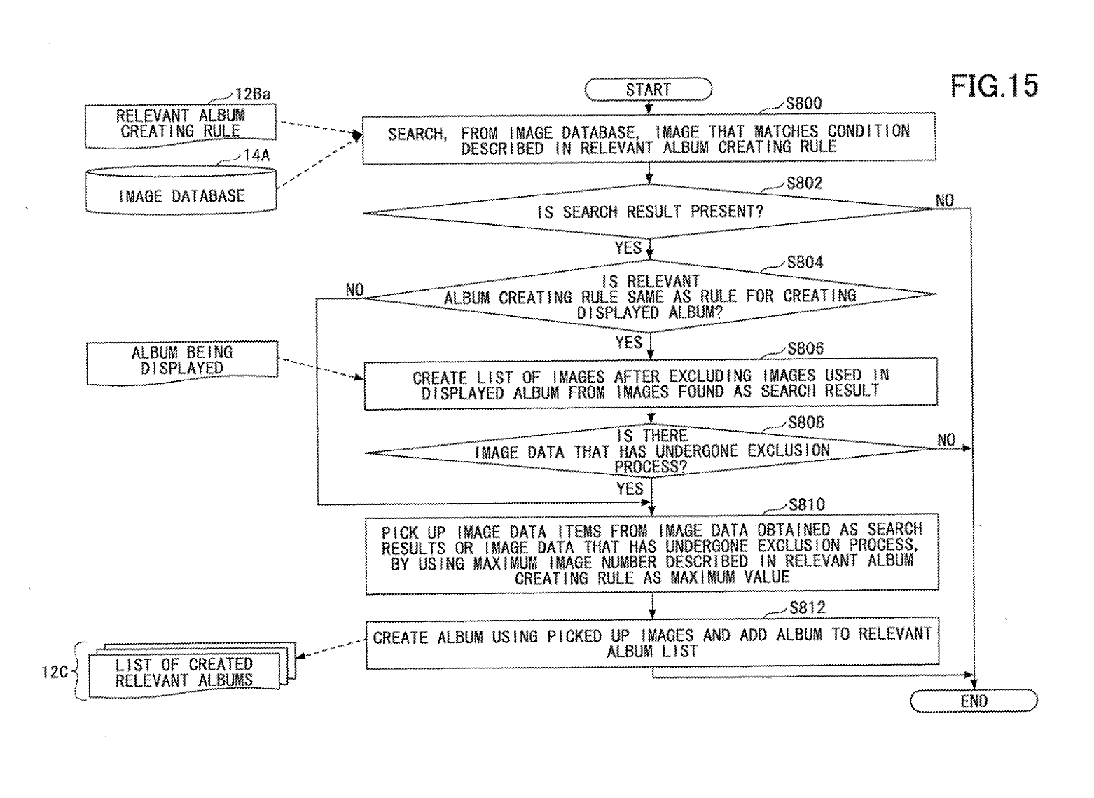

FIG. 15 is a flowchart indicating a flow of a relevant album data creating process. The process of the present flowchart is executed by the second creating part A_2.

First, the second creating part A_2 extracts the date condition and time condition described in a relevant album creating rule 12Ba acquired in step S706 of FIG. 14, and searches for an image matching the date condition and time condition from the image database 14A (step S800).

Next, the second creating part A_2 determines whether image data is present as a search result (step S802).

When there is image data present as a search result, the second creating part A_2 determines whether the relevant album creating rule 12Ba and the rule for creating an album being displayed are the same (step S804).

When the relevant album creating rule 12Ba and the rule for creating an album being displayed are the same, the second creating part A_2 creates a list in which the image data used for the album being displayed is excluded from the image data found as search results in step S800 (step S806).

Next, the second creating part A_2 determines whether there is image data from which the images used for the album being displayed are excluded, among the image data found as search results in step S800 (step S808).

When there is image data that has undergone the exclusion process and when the determination result is negative in step S804, the second creating part A_2 picks up image data items from the image data obtained as search results or the image data that has undergone the exclusion process, with the maximum number of images described in the relevant album creating rule used as the maximum value (step S810). In step S810, the second creating part A_2 compares the number of image data items obtained as search results or image data items included in the list created at step S806, with the maximum number of images described in the relevant album creating rule. Then, when the number of image data items obtained as search results or image data items remaining after the exclusion process is less than or equal to the maximum number of images, the second creating part A_2 picks up a number of image data items corresponding to the number of image data items obtained as search results or image data items remaining after the exclusion process. Meanwhile, when the number of image data items obtained as search results or image data items remaining after the exclusion process is greater than the maximum number of images, the second creating part A_2 picks up a number of image items corresponding to the maximum number of images. The method of picking up images may be to randomly select images, or to exclude unsuccessful photographs such as blurred images or images that include subjects that are not supposed to be included.

Next, the second creating part A_2 creates an album based on the picked up images, adds the created album to the list of created relevant albums 12C (step S812), and ends the process of the present flowchart. The list of created relevant albums 12C may only be stored in the RAM 12 (that is to say, the list of created relevant albums 12C is erased when the power is turned off), or may be stored in the HDD 14 when the device is shut down to be saved.

When the determination result is negative in step S802 or S808, the second creating part A_2 ends the process of the present flowchart.
Example of Screen

In the following, a description is given of changes of the displayed screen according to the above-described process.

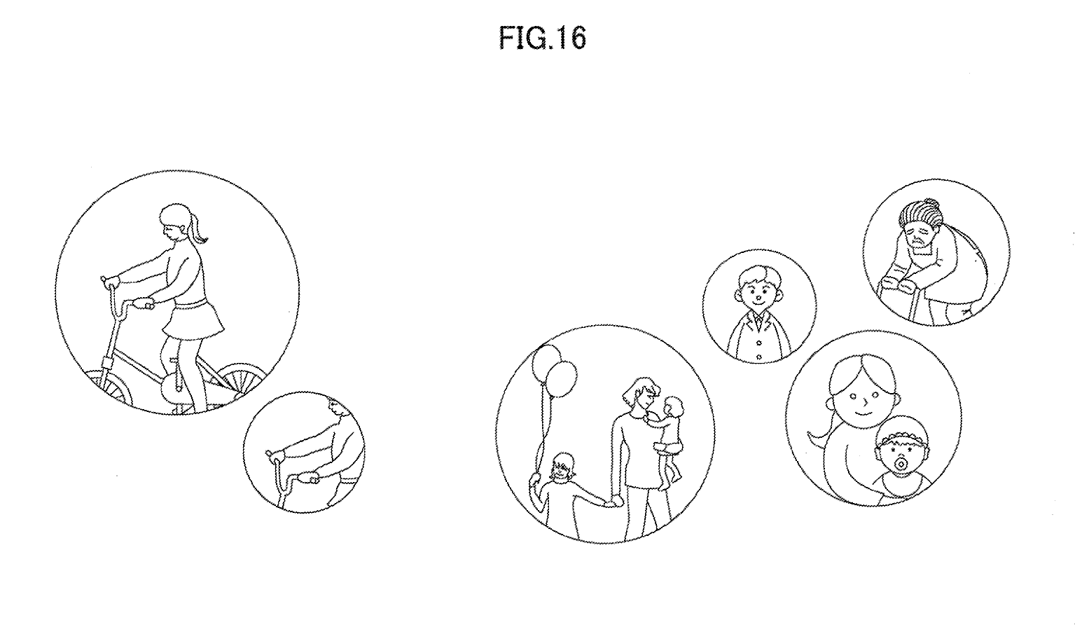

FIG. 16 illustrates an example of a displayed screen of the image display unit D when an album is being reproduced.

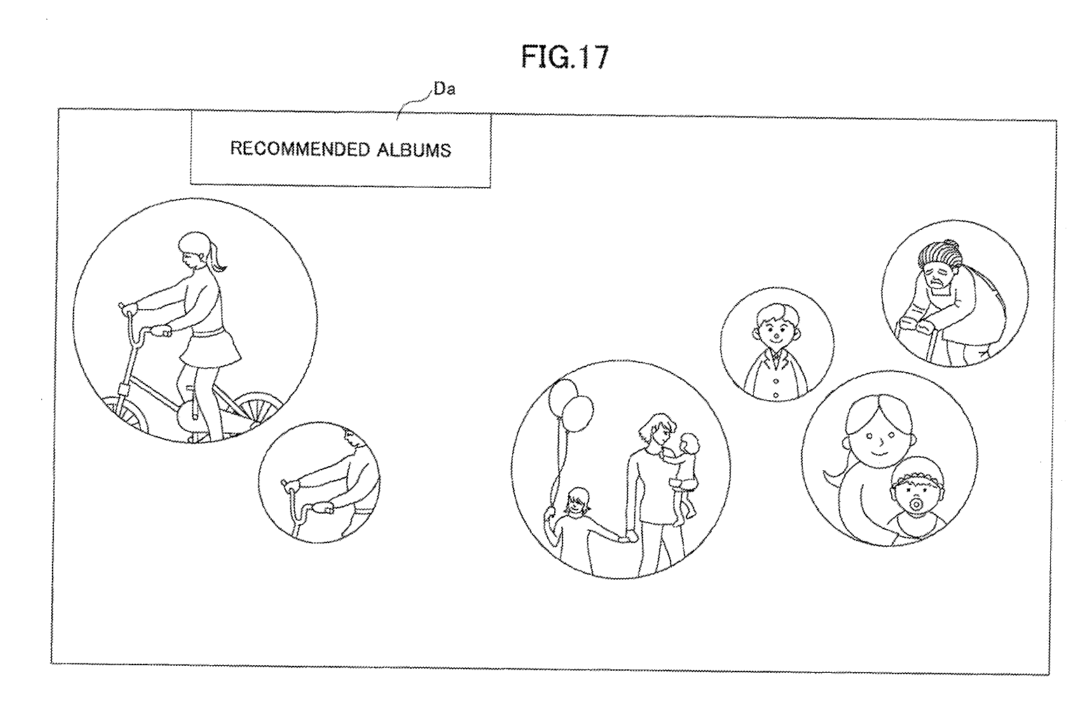

When the user speaks a voice keyword relevant to an album being displayed while the screen illustrated in FIG. 16 is displayed, a relevant album is created. As a result, as illustrated in FIG. 17, for example, an image area Da that reads “recommended albums” is displayed as a pop-up. FIG. 17 is an example of a displayed screen of the image display unit D when a relevant album is created.

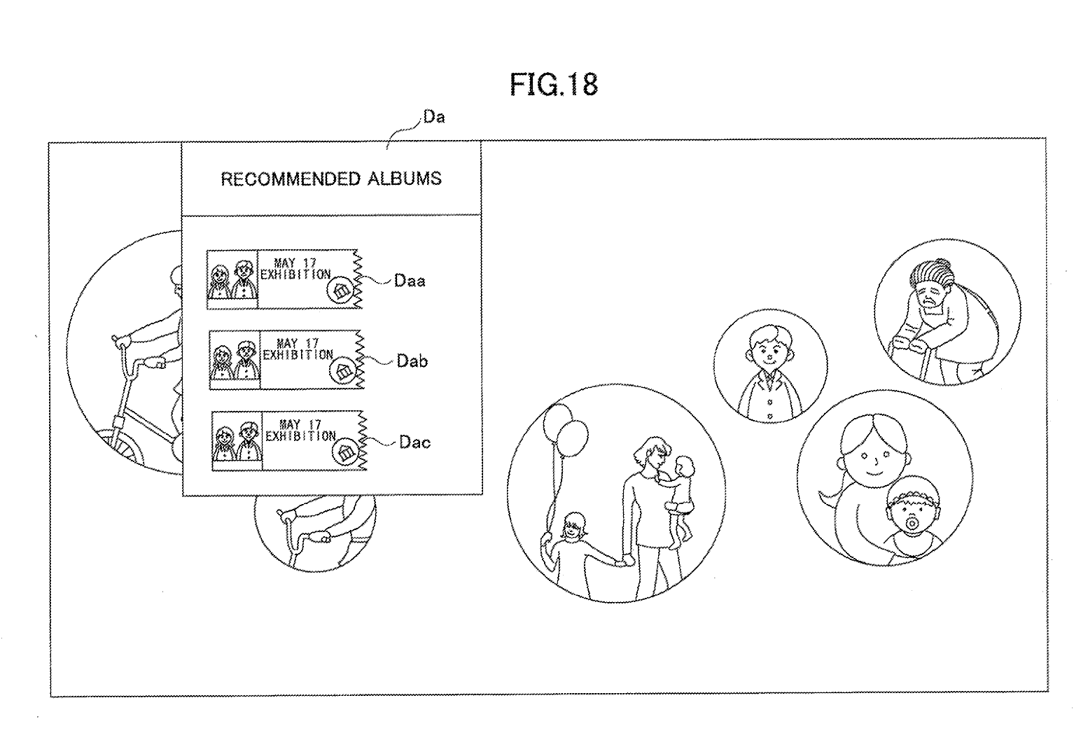

When the user clicks or touches the image area Da reading “recommended albums”, as illustrated in FIG. 18, a list of recommended albums (=relevant albums created based on the voice keyword) is displayed by a drop-down. FIG. 18 illustrates how a list of relevant albums is displayed by the image display unit D. When the user clicks or touches any of the albums in the list of relevant albums, reproduction of the selected relevant album is started. In FIG. 18, Daa, Dab, and Dac are the instruction areas for reproducing the respective relevant albums.
Overview

According to the image reproducing device and the image reproducing method according to the first embodiment described above, when an album is reproduced, it is possible to set a rule for creating a relevant album based on the relationship between voice keywords spoken by the user and rules for creating the album. Furthermore, according to the image reproducing device according to the first embodiment, it is possible to create a relevant album, and present information pertinent to the relevant album. As a result, according to the image reproducing device according to the first embodiment, it is possible to provide images suited to the intensions of the user.

Furthermore, according to the image reproducing device according to the first embodiment, an extraction condition for narrowing down the condition pertinent to a time period is set in the voice keyword database 14D, and therefore it is possible to create a relevant album focusing on an extraction range that the user is likely to be interested in, and provide the relevant album.

Furthermore, according to the image reproducing device according to the first embodiment, an extraction condition indicating a time period that comes before or after the original time condition is set in the voice keyword database 14D, and therefore it is possible to respond to cases where the user is interested in a wider range.
Second Embodiment

In the following, a description is given of an image reproducing device and an image reproducing method according to a second embodiment of the present invention, with reference to accompanying drawings.

The image reproducing device according to the second embodiment is the same as the image reproducing device according to the first embodiment in terms of the overall diagram, the hardware configuration, and the logical configuration, and therefore common elements are denoted by the same reference numerals, and the differences are mainly described below.

An image reproducing device 2 according to the second embodiment creates a relevant album of a specified period (same as the first embodiment) and a relevant album relevant to a particular person, based on voice keywords detected while image data is reproduced.

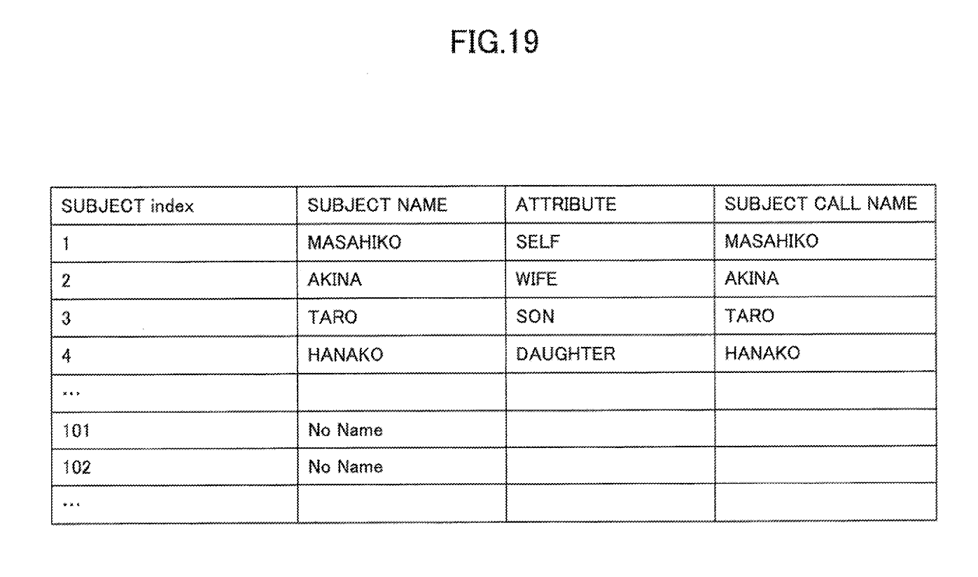

FIG. 19 illustrates an example of data stored in the image database 14A according to the second embodiment. In FIG. 19, a “subject index” is a unique ID for uniquely identifying a subject. A “subject name” is a character string in a format that the user understands. As the subject name, for example, the name of a subject is to be recorded. As for a subject that is recognized, but the subject does not have a particular name, “No Name” is described, to indicate that a name is not given yet. “Attribute” indicates the relationship between the subject, and self, wife, son, daughter, friend, colleague are described. “Subject call name” indicates how the subject name is called, which is registered for voice recognition.

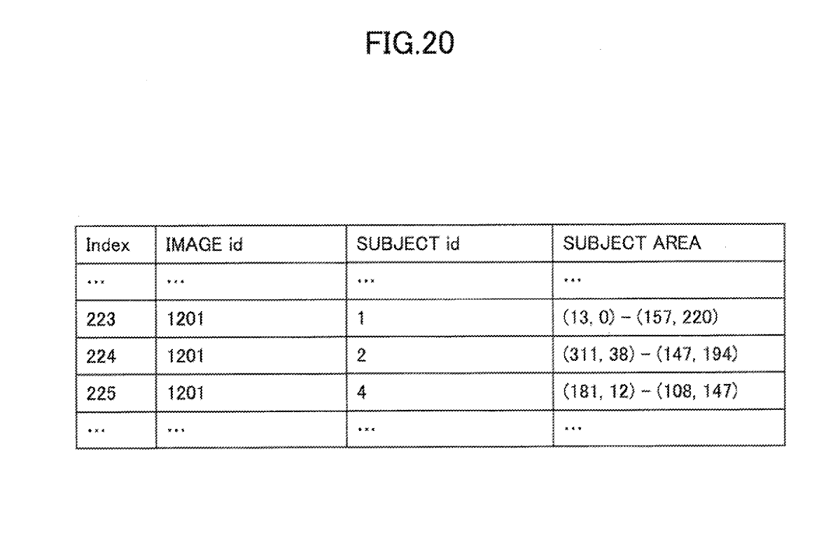

FIG. 20 is an example of an image subject association table stored as an attachment in the image database 14A according to the second embodiment. In FIG. 20, “Index” is a unique ID for uniquely identifying data. “Image id” is ID information indicating an image managed in an image table of the image database 14A. “Subject id” is ID information indicating a subject managed in a subject table of the image database 14A. “Subject area” expresses the area including the face of the subject in the image. As the area of the face, area information that has been determined at the time of a face recognition process is to be described. For example, the area of the face is expressed in a format of “(top left coordinate)-(bottom right coordinate)”of the area of the face. The area of the face may be expressed by another description method by which the area is determined. For example, a description method such as “(top left coordinate)−vertical size×horizontal size” may be used.

In FIG. 20, the photograph of image id=1201 corresponds to three records of Index=223, 224, 225. The Index=223 indicates that the face of the subject id=1 is included in an area of (13, 0)-(157, 220) in the image id=1201. Similarly, the Index=224 indicates that the face of the subject id=2 is included in an area of (311, 38)-(147, 194) in the image id=1201. Furthermore, the Index=225 indicates that the face of the subject id=4 is included in an area of (181, 12)-(108, 147) in the image id=1201.

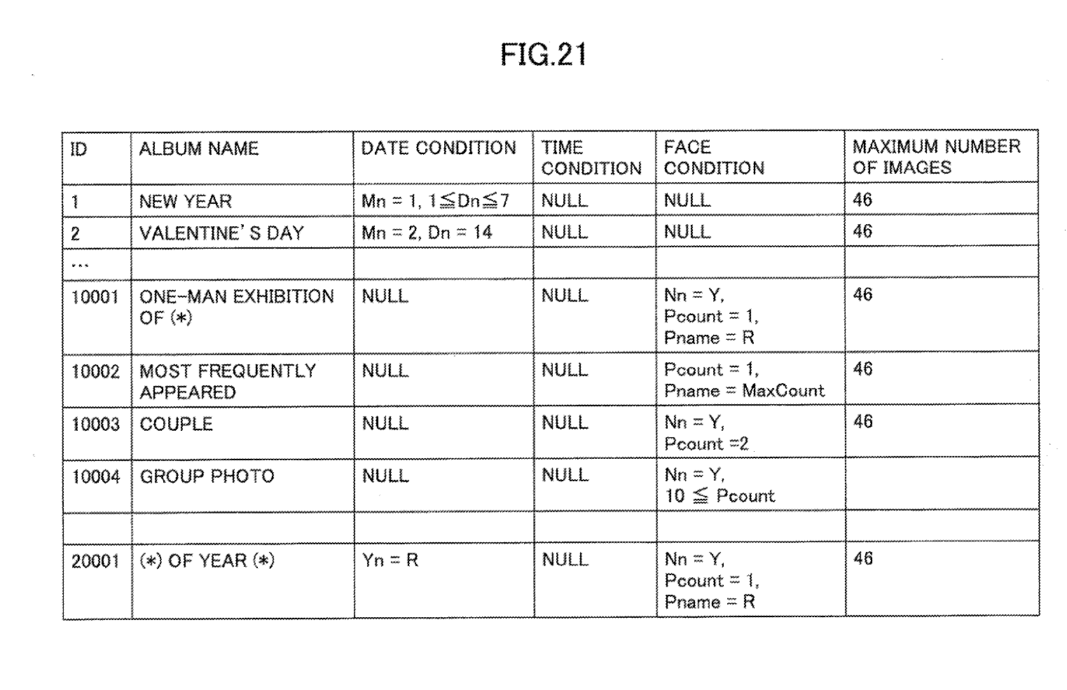

FIG. 21 illustrates an example of data stored in the album rule database 14B according to the second embodiment. The album rule database 14B according to the second embodiment is formed by adding album rules pertinent to face recognition to the data stored in the album rule database 14B according to the first embodiment.

In FIG. 21, “ID”, “album name”, “date condition”, “time condition”, and “maximum number of images” are the same as those of the first embodiment.

“Face condition” is a parameter unique to the second embodiment, which describes conditions of face recognition results for images collected when creating each album.

“Face condition” follows the following rules.

Nn indicates a condition defining whether there is a registered name. When there is no description, all people that are recognized are the targets. When Y is described, only the person whose name is registered is the target. When N is described, only the people whose names are not registered are the targets.

Pcount indicates a condition of the number of people included in the image. When there is no description, the number of people is not limited. When the number is described, images including a number of people corresponding to the described number are targets. For example, in the case of the album of ID=10004, the condition of Pcount is “10≦Pcount”, which means “image including 10 people or more”.

Pname indicates a condition of whether a particular person is included in the image. When there is no description, the subject is not specified. When a value of a subject is described, the condition specifies images including the person corresponding to the value. When R is described, the value of the index is randomly selected from possible values. For example, in the case of an album of ID=10001, the condition of Pname is “Pname=R”. When the value of R is randomly selected and the result is R=3, the condition becomes “images including Taro”. Furthermore, the album name includes (*), and therefore in this the album name becomes “One-man exhibition of Taro”. In this example, there is a condition of “Pcount=1”, and therefore the condition is “album including only Taro”.

Furthermore, in the case of MaxCount, the number of all people included in the images is counted, and the index of the person who appears in the largest number of images is assigned. Accordingly, it is possible to create an album of the person who most frequently appears in the images in the system.

It is possible to combine the “face condition” with the date condition and the time condition. For example, when an album is created with “images of 2009 including Hanako”, the date condition is “Yn=2009” and the face condition is “Pname=4”.

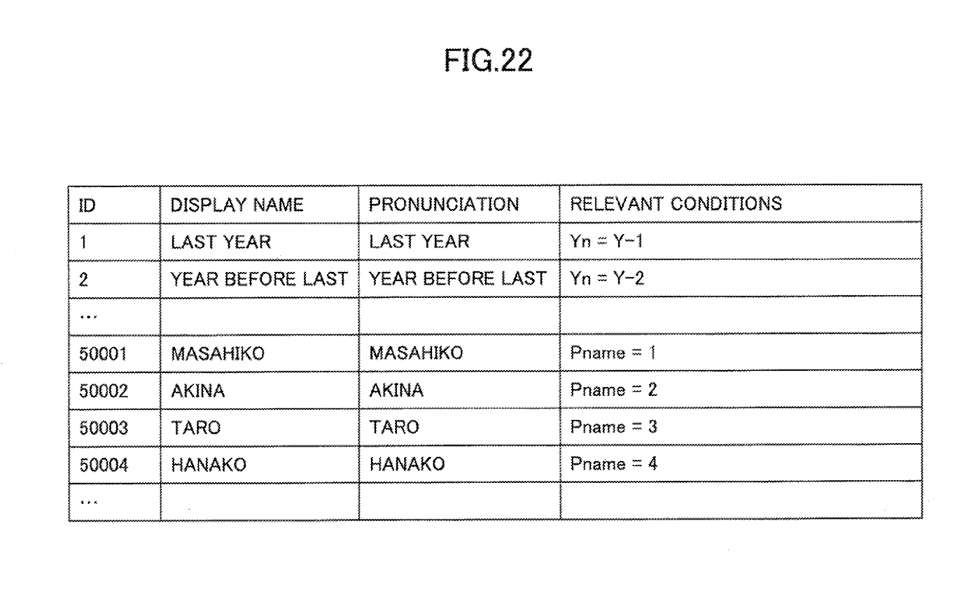

FIG. 22 illustrates an example of data stored in the voice keyword database 14D according to the second embodiment. The voice keyword database 14D according to the second embodiment is formed by adding keywords pertinent to face recognition to the data stored in the voice keyword database 14D according to the first embodiment. In FIG. 22, the items from and beyond ID=50001 are keywords pertinent to face recognition. In “display name”, the subject name in the subject table is copied. In “pronunciation”, the call name (how the name is called) of the subject in the subject table is copied. In “relevant condition”, the value of the subject index in the subject table is described as the condition.
Main Process

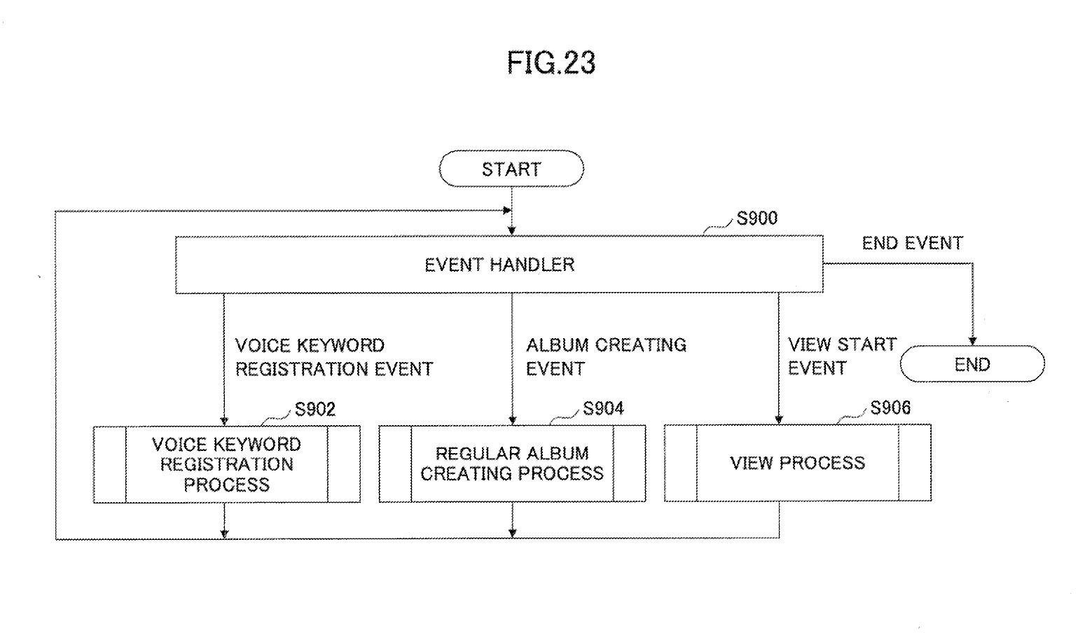

FIG. 23 is a flowchart indicating the flow of a main process executed by the image reproducing device 2 according to the second embodiment.

When the image reproducing device 2 is activated, an event handler becomes resident (step S900). The event handler is provided in various operating systems, and performs various processes in response to regular/irregular event reports.

When a “voice keyword registration event” is reported from the event handler, a “voice keyword registration process” starts (step S902). A voice keyword registration process is for receiving registration of data in a voice keyword database by user operation. The data to be registered is recognition data that is a result of face recognition performed on the image data selected by the user, the person's name, and the pronunciation of the name. By the voice keyword registration process, it is possible to recognize the person as a voice keyword when the user calls the person's name.

When an “album creating event” is reported from the event handler, a “regular album creating process” starts (step S904). The regular album creating process is the same as that of the first embodiment, and is thus not further described.

Furthermore, when a “view start event” is reported from the event handler, a “view process” is started (step S906). The view process is the same as that of the first embodiment, and is thus not further described.

Furthermore, when an “end event” is reported from the event handler, the operating system itself is ended.

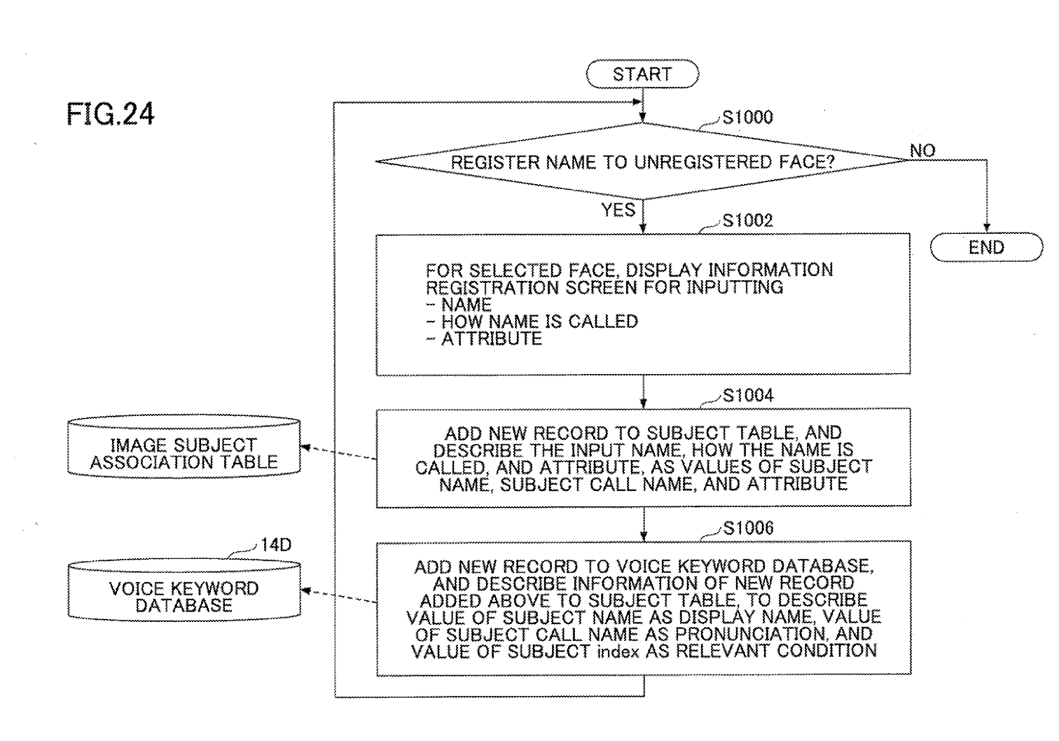

FIG. 24 is a flowchart indicating the flow of a voice keyword registration process executed by the image reproducing device 2 according to the second embodiment. For example, the present flowchart is executed as a function of the voice keyword extracting unit F. Furthermore, the present flowchart is started after instructing the image reproducing device 2 to perform a face recognition process on image data desired by the user, or after the image reproducing device 2 automatically performs a face recognition process on a newly registered image.

First, the user is prompted to select whether to register a name for a face image for which a name has not yet been registered, among the faces that have been recognized by a face recognition function (step S1000). When the user selects not to register a name, the voice keyword extracting unit F ends the process of the present flowchart.

When the user selects to register a name, the voice keyword extracting unit F displays an information registration screen to be used by the user for registering information such as a name in association with the face, and waits for a user to input information (step S1002).

When the user inputs information, the voice keyword extracting unit F writes, in an image subject association table attached in the image database 14A, the name, how the name is called, and attribute information input by the user (step S1004). The voice keyword extracting unit F writes in the name as a “subject name”, the attribute as an “attribute”, and how the name is called as a “subject call name”.

Next, the voice keyword extracting unit F writes the added value of the image subject association table in the voice keyword database 14D (step S1006), and returns to step S1000. The voice keyword extracting unit F writes the subject name as “display name”, the subject call name as “call name”, and the subject index as “relevant condition”.

By the above process, a name associated with a face image is registered as a voice keyword, and when the voice keyword is spoken, a relevant album is created, and an image area Da including a “recommended album” is displayed as in the first embodiment.

In the following, other processes are described.

As to the regular album creating process, the main flow is similar to that of the first embodiment. However, in step 5300 of the flowchart in FIG. 10, an option of an album created by face recognition is included in the rules for the album to be presently created. For example, at the end of the year in 2011, when an album of a person who has been photographed during 2011 is to be created, an album such as “Masahiko in 2011”, “Akina in 2011”, “Taro in 2011”, and “Hanako in 2011” is to be selected. Accordingly, an album pertinent to face recognition is created in the regular album creating process.

As to the view process, the call name of the name is registered in the voice keyword database 14D, and therefore when the name registered in the voice keyword database 14D is spoken while reproducing images, the relevant album creating process is started.

In the relevant album creating process, when the detected voice keyword is “Taro”, the voice keyword database 14D is searched, and ID=50003 is obtained. The second creating part A_2 refers to the value in the field of relevant conditions in the corresponding record, and acquires a relevant condition “Pname=3”. When the album presently being displayed is “One-man exhibition of Hanako” (in the case of ID=10001, R=4), the second creating part A_2 according to the second embodiment acquires the date condition, time condition, and face condition of this album. In this case, the date condition and time condition are NULL, and the face condition is “Nn=Y, Pcount=1, Pname=4”.

The second creating part A_2 according to the second embodiment creates the relevant album pertinent to the date condition and the time condition by the same logic as the first embodiment. Meanwhile, as to the face condition, the second creating part A_2 according to the second embodiment uses two conditions of a case where the logical product (AND) is taken and a case where a new condition is set. In the above example, when the logical product (AND) is taken, the condition is “Nn=Y, Pcount=1, Pname=3AND4”. However, this condition contradicts the condition of “Taro and Hanako are included in the same image, and the number of subjects is one”, and therefore it is not possible to take the logical product (AND). In this case, a new condition is used, which is “Nn=Y, Pcount=1, Pname=3”, and “One-man exhibition of Taro” is created. According to the above process, when a word “Taro” is spoken while reproducing the album of the One-man exhibition of Hanako, an album of “One-man exhibition of Taro” is created as a relevant album.

In the present embodiment, an example of a face tag according to a face recognition function is described; however, it is possible to apply the same technology to another tag according to another recognition method. For example, when there is an image analyzing engine for analyzing the contents of a meal, tags such as “French food” and “foie gras” may be added to each image. Accordingly, by registering how these tags are called, it is possible to display a relevant album such as an “Album of French food” by the same process as the present embodiment.

According to the image reproducing device and the image reproducing method according to the second embodiment, when an album is being reproduced, it is possible to set rules for creating a relevant album based on the relationship between voice keywords included in words spoken by the user and album creating rules. Furthermore, according to the image reproducing device according to the second embodiment, it is possible to create a relevant album and present information pertinent to the relevant album. As a result, according to the image reproducing device according to the second embodiment, it is possible to provide images suited to the user's intentions.

Furthermore, according to the image reproducing device according to the second embodiment, extraction conditions pertinent to people are set in the voice keyword database 14D, and therefore it is possible to propose reproduction of images about a person that the user is interested in at the present time point.
Third Embodiment

In the following, a description is given of an image reproducing device and an image reproducing method according to a third embodiment of the present invention, with reference to accompanying drawings.

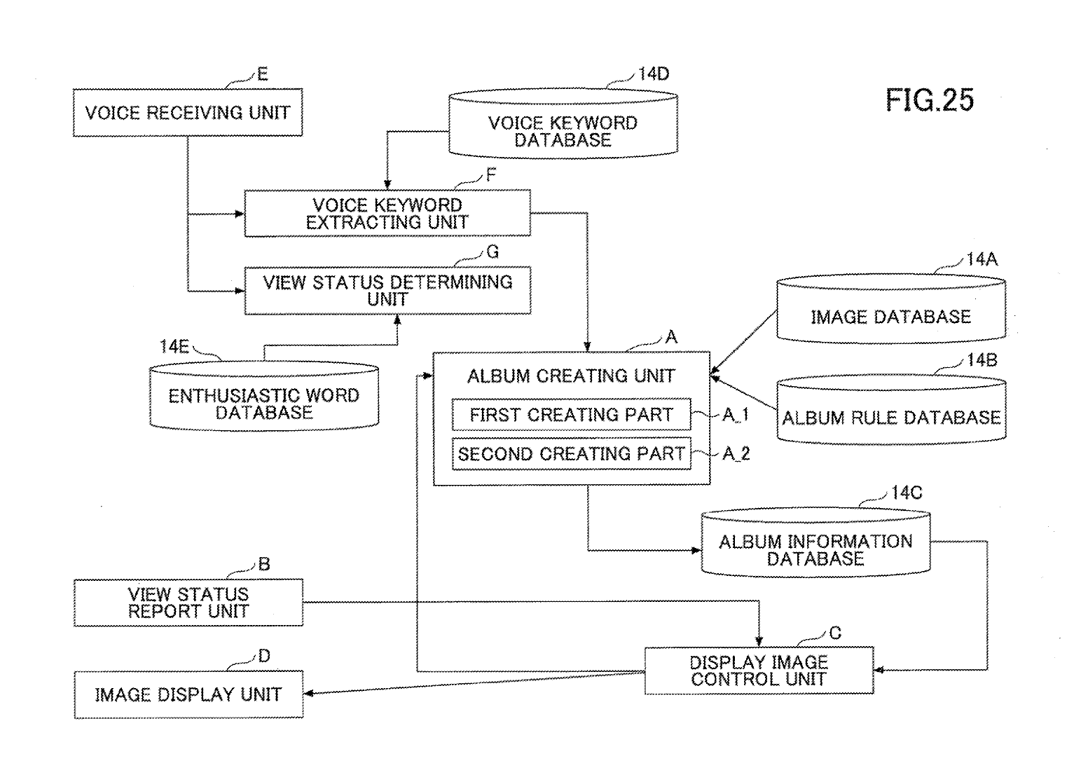

FIG. 25 illustrates a logical configuration of an image reproducing device 3 according to the third embodiment. The image reproducing device 3 includes an album creating unit A, a view status report unit B, a display image control unit C, an image display unit D, a voice receiving unit E, a voice keyword extracting unit F, and a view status determining unit G. For example, the first creating part A_1 according to the present embodiment corresponds to an “extracting unit”. For example, the second creating part A_2, the display image control unit C, and a voice receiving handler of the present embodiment correspond to the “presenting unit”. For example, an album according to the present embodiment corresponds to “first-condition-satisfying-image data”. For example, a relevant album according to the present embodiment corresponds to “second-condition-satisfying-image data”.

Among these logical configurations, the album creating unit A, the view status report unit B, the display image control unit C, the voice keyword extracting unit F, and the view status determining unit G are functional blocks that function as the CPU 10 executes programs stored in the HDD 14. The operations are not always implemented by programs clearly separated by these functional blocks. The operations may be called as subroutines and functions by other programs. Some of the functional blocks may be hardware units such as a LSI, an IC, and a FPGA.

The image display unit D corresponds to the graphic interface 20 and the television broadcasting device 100, and the voice receiving unit E is a function of the input interface 22.

The respective logical configurations in FIG. 25 perform processing with the use of the image database 14A, the album rule database 14B, the album information database 14C, the voice keyword database 14D, and an enthusiastic word database 14E stored in the HDD 14.

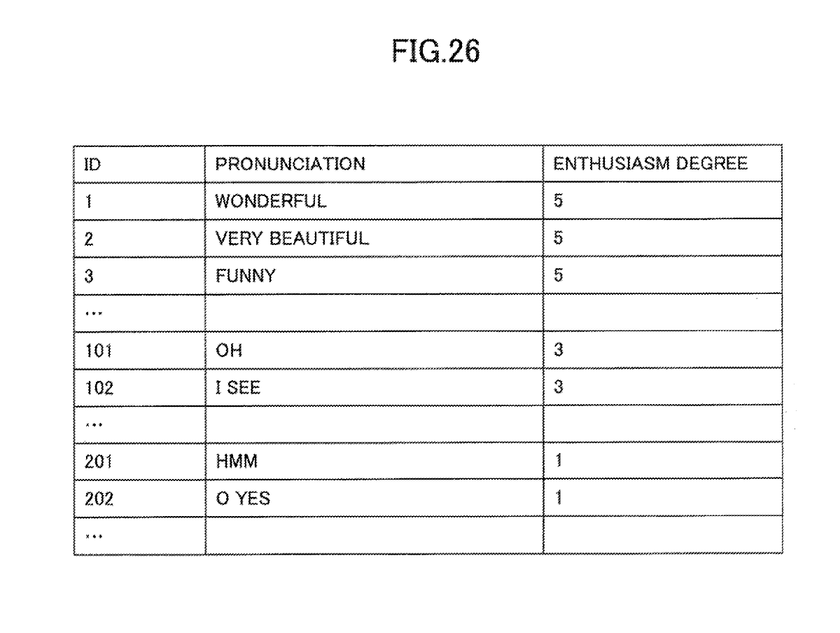

The enthusiastic word database 14E is a collection of words indicating enthusiasm included in words spoken by the user. FIG. 26 illustrates an example of data stored in the enthusiastic word database 14E. In FIG. 26, “ID” is a unique value for uniquely identifying an enthusiastic word. “Pronunciation” is a keyword for matching a voice input from the voice receiving unit E with a voice by a voice recognition technology. This is used for determining whether the word is pronounced as described in this database. “Enthusiasm degree” is obtained by converting enthusiasm into a value, and as the value becomes higher, it is determined as more enthusiastic. In the example of FIG. 25, the maximum value of an enthusiasm degree is 5, and the minimum value is 1.

The main differences between the image reproducing device 3 according to the third embodiment and the image reproducing device 1 according to the first embodiment are the view process and a process by the voice recognition module, and therefore only the differences are described below.

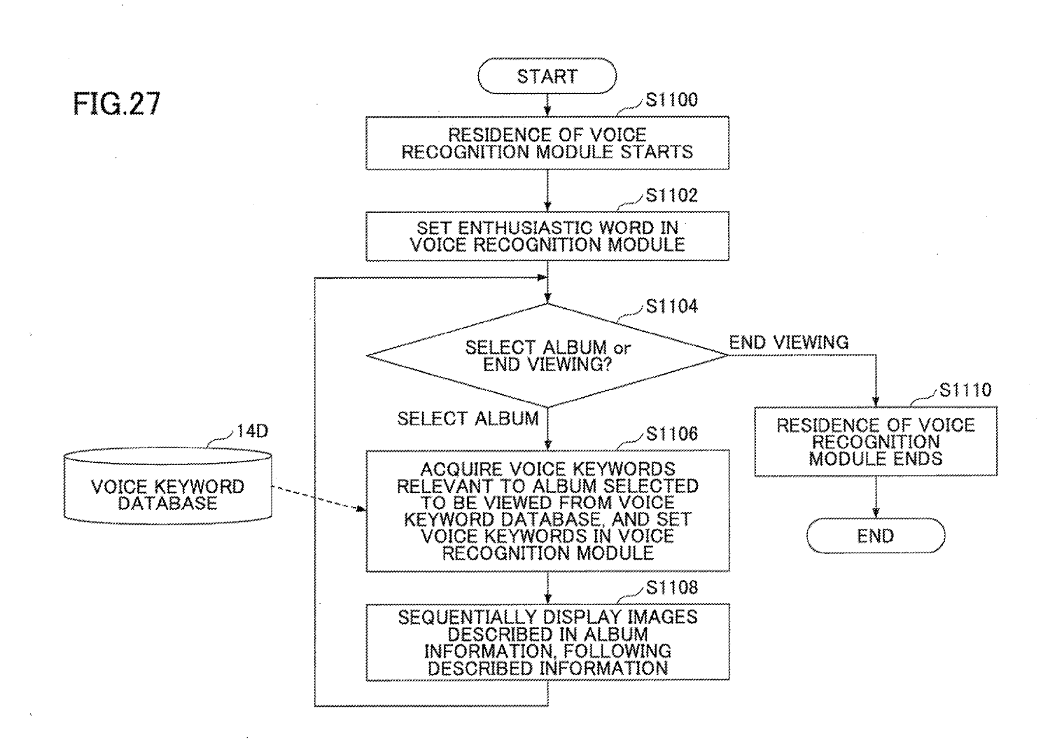

FIG. 27 is a flowchart indicating a flow of a process executed by the image reproducing device 3 according to the third embodiment.

First, the display image control unit C causes the voice recognition module become resident (step S1100). The voice recognition module sets the voice receiving unit E so that voices from the microphone 46 are received, and makes preparations for the voice keyword extracting unit F to consecutively analyze the voices received from the voice receiving unit E.

Next, the display image control unit C sets enthusiastic words in the voice recognition module (step S1102).

Next, the display image control unit C waits until a user selects an album or selects to end viewing (step S1104).

When the user selects an album, the display image control unit C acquires voice keywords relevant to the album to be viewed from the voice keyword database 14D, and sets the voice keywords in the voice recognition module (step S1106).

Here, for acquiring the list of relevant keywords, for example, the display image control unit C uses a list in which the rules described in the album rule database 14B are associated with corresponding keywords. Then, the display image control unit C reads, from the list, a keyword corresponding to the rule ID described in the album that the user is going to view.

Next, the display image control unit C causes the image display unit D to display images identified by the album information, following the information described in the album information (step S1108). Accordingly, the user starts to view an album. When a user speaks a voice during this time, the resident voice recognition module reacts, and performs the process of the voice recognition module described below. When the user finishes viewing an album or when the user performs an operation to view another album, the display image control unit C returns to step S1104 and executes the process.

When the user selects view end, the display image control unit C ends the residence of the voice recognition module (step S1110).
Process of Voice Recognition Module

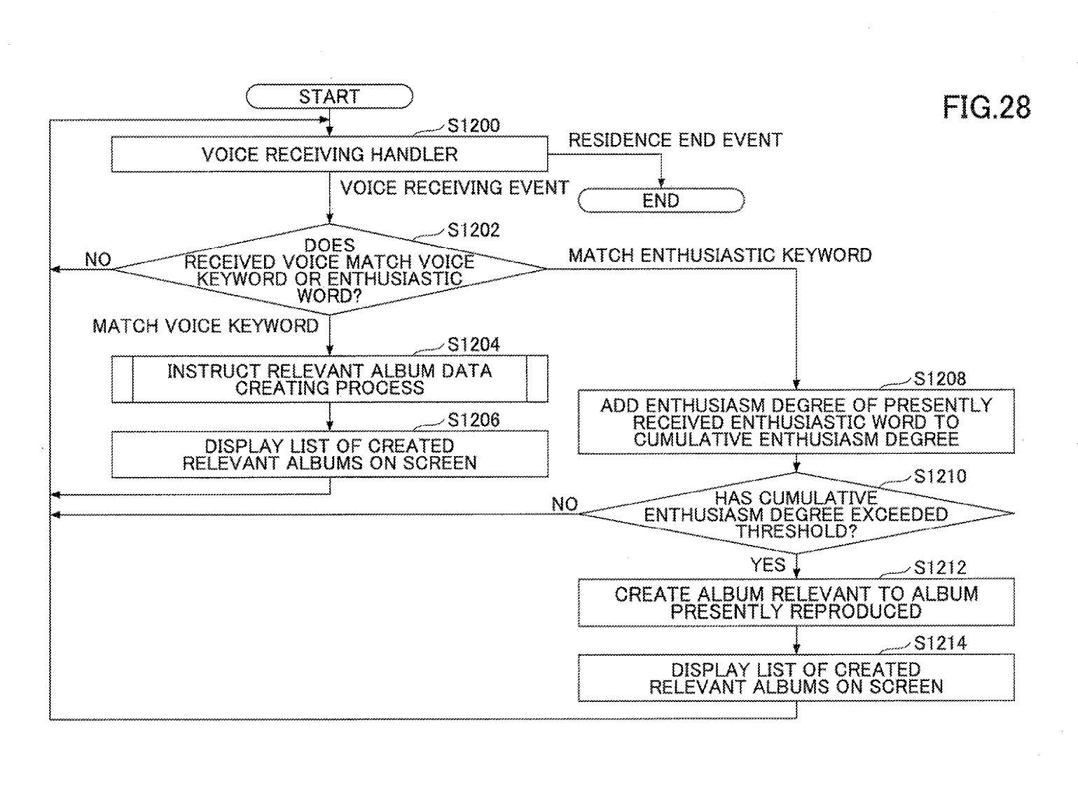

FIG. 28 is a flowchart indicating a flow of a process of a voice recognition module.

When the voice recognition module starts to become resident, the voice receiving handler is activated (step S1200). The voice receiving handler waits to receive a message according to the event that has occurred.

When a voice receiving event is received, the voice receiving handler causes the voice keyword extracting unit F to determine whether the received voice matches a set voice keyword or enthusiastic word (step S1202). When the received voice does not match any set voice keyword or enthusiastic word, the voice receiving handler returns to step S1200 and waits to receive a message.

Meanwhile, when the received voice matches the set voice keyword, the voice receiving handler instructs the second creating part A_2 to create a relevant album relevant to the album presently viewed by the user and the received keyword (step S1204).

When the creation of the relevant album is completed, the voice receiving handler instructs the display image control unit C to display a list of created relevant albums 12C on a screen (step S1206).

When a new voice receiving event is received while the second creating part A_2 is creating a relevant album, the voice receiving handler may perform a thread process, where a process of step S1204 is performed in parallel with the present process. Furthermore, the voice receiving handler may ignore the reception of the next voice receiving event until the relevant album creating process is completed.

Meanwhile, when the received voice matches the set enthusiastic keyword, the voice receiving handler adds, to a cumulative enthusiasm degree, the enthusiasm degree of the enthusiastic word presently received (step S1208).

Then, the voice receiving handler determines whether the cumulative enthusiasm degree exceeds a threshold (step S1210). When the cumulative enthusiasm degree does not exceed the threshold, the voice receiving handler returns to step S1200 and waits to receive a message.

When the cumulative enthusiasm degree exceeds the threshold, the voice receiving handler instructs the second creating part A_2 to create an album relevant to the album presently being reproduced (step S1212).

When the creation of the relevant album is completed, the voice receiving handler instructs the display image control unit C to display a list of created albums relevant to the album presently being displayed on a screen (step S1214).

When the voice receiving handler receives a residence end event, the voice recognition module ends the residence.

In step S1210, for example, when 8 is set as the threshold, and two enthusiastic words of “wonderful” and “very beautiful” are detected, the enthusiasm degree becomes 10 and exceeds the threshold. When two enthusiastic words of “oh” and “I see” are detected, the enthusiasm degree becomes 6 and does not exceed the threshold.

When creating a relevant album when the cumulative enthusiasm degree exceeds the threshold, by creating an album that is deeply relevant to the album presently being displayed, it is possible to make the enthusiasm continue. Accordingly, the relevant album is to be created by the following rules.

An album focusing on a particular period of the album being viewed (for example, in a case of an “album of 2007”, “January to June in 2007” or “July to December in 2007,” and in a case of an “album of New Year”, “New Year of 2010” and “New Year of 2011”).

An album focusing on a subject in the album being viewed (for example, in a case of “album of 2007”, “album of Taro in 2007” and “album of Hanako in 2007”).

A list of relevant albums created according to enthusiastic words may be displayed together with a list of relevant albums created according to voice keywords, or may be displayed separately.

According to the flow of the above process, it is possible to recognize enthusiasm while a user is viewing an album, and propose a new album relevant to the present album.

According to the image reproducing device and the image reproducing method according to the third embodiment described above, when an album is being reproduced, it is possible to set rules for creating a relevant album based on the relationship between voice keywords included in words spoken by the user and album creating rules. Furthermore, according to the image reproducing device according to the third embodiment, it is possible to create a relevant album and present information pertinent to the relevant album. As a result, according to the image reproducing device according to the third embodiment, it is possible to provide images suited to the user's intentions.

Furthermore, according to the image reproducing device according to the third embodiment, a relevant album is created when an enthusiastic word set in advance is spoken and the enthusiasm degree exceeds a threshold, and therefore it is possible to provide images suited to the user's state.

According to an aspect of the present invention, an image reproducing device is provided, which is capable off providing images suited to the intentions of the user.

The present invention is not limited to the specific embodiments described herein, and variations and modifications may be made without departing from the scope of the present invention.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An image reproducing device connected to a reproducing unit that reproduces image data, the image reproducing device comprising:
an extraction unit configured to extract first-condition-satisfying-image data that satisfies a first extraction condition from image data stored in a storage unit;
a voice keyword extraction unit configured to extract a keyword that matches a voice input to a voice input unit; and
a presentation unit configured to determine, while the first-condition-satisfying-image data is being reproduced by the reproducing unit, a second extraction condition based on a relationship between the first extraction condition applied when extracting the first-condition-satisfying-image data being reproduced and the keyword that has been extracted, and present information pertinent to second-condition-satisfying-image data that satisfies the second extraction condition among the image data stored in the storage unit.

2. The image reproducing device according to claim 1, wherein
the second extraction condition is for extracting the image data by a narrower extraction range than the first extraction condition.

3. The image reproducing device according to claim 1, wherein
the first extraction condition is pertinent to a time period, and
the second extraction condition is for extracting the image data of a time period that comes before or after the time period of the first extraction condition.

4. The image reproducing device according to claim 1, wherein
the second extraction condition is for extracting image data including a particular person.

5. An image reproducing device connected to a reproducing unit that reproduces image data, the image reproducing device comprising:
an extraction unit configured to extract first-condition-satisfying-image data that satisfies a first extraction condition from image data stored in a storage unit;
a voice keyword extraction unit configured to extract a keyword that indicates enthusiasm of a user from a voice input to a voice input unit; and
a presentation unit configured to calculate, while the first-condition-satisfying-image data is being reproduced by the reproducing unit, an enthusiasm degree of the user based on the keyword indicating enthusiasm of the user that has been extracted, and present information pertinent to second-condition-satisfying-image data that satisfies a second extraction condition relevant to the first extraction condition among the image data stored in the storage unit, according to the enthusiasm degree of the user that has been calculated.

6. A non-transitory computer-readable recording medium storing an image reproducing program that causes a computer, which is connected to a reproducing unit that reproduces image data, to execute a method comprising:
extracting first-condition-satisfying-image data that satisfies a first extraction condition from image data stored in a storage unit;
extracting a keyword that matches a voice input to a voice input unit; and
determining, while the first-condition-satisfying-image data is being reproduced by the reproducing unit, a second extraction condition based on a relationship between the first extraction condition applied when extracting the first-condition-satisfying-image data being reproduced and the keyword that has been extracted, and presenting information pertinent to second-condition-satisfying-image data that satisfies the second extraction condition among the image data stored in the storage unit.

7. The non-transitory computer-readable recording medium according to claim 6, wherein
the second extraction condition is for extracting the image data by a narrower extraction range than the first extraction condition.

8. The non-transitory computer-readable recording medium according to claim 6, wherein
the first extraction condition is pertinent to a time period, and
the second extraction condition is for extracting the image data of a time period that comes before or after the time period of the first extraction condition.

9. The non-transitory computer-readable recording medium according to claim 6, wherein
the second extraction condition is for extracting image data including a particular person.

10. A method for reproducing images performed by a computer connected to a reproducing unit that reproduces image data, the method comprising:
extracting first-condition-satisfying-image data that satisfies a first extraction condition from image data stored in a storage unit;
extracting a keyword that matches a voice input to a voice input unit; and
determining, while the first-condition-satisfying-image data is being reproduced by the reproducing unit, a second extraction condition based on a relationship between the first extraction condition applied when extracting the first-condition-satisfying-image data being reproduced and the keyword that has been extracted, and presenting information pertinent to second-condition-satisfying-image data that satisfies the second extraction condition among the image data stored in the storage unit.
